(19) United States
(12) Patent Application Publication
(10) Pub. No.: US 2026/0161343 A1
(43) Pub. Date: Jun. 11, 2026

(54) WEARABLE DEVICE, METHOD, AND NON-TRANSITORY COMPUTER-READABLE STORAGE MEDIA FOR RECOGNIZING DATA OF ELECTRONIC DEVICE AS INPUT

(71) Applicant: Samsung Electronics Co., Ltd., Suwon-si (KR)

(72) Inventors: Donghyun YEOM, Suwon-si (KR); Kwangtai KIM, Suwon-si (KR); Seungnyun KIM, Suwon-si (KR); Jihyun KIM, Suwon-si (KR); Dongil SON, Suwon-si (KR); Bokun CHOI, Suwon-si (KR)

(21) Appl. No.: 19/251,033

(22) Filed: Jun. 26, 2025

Related U.S. Application Data
(63) Continuation of application No. PCT/KR2025/006855, filed on May 20, 2025.

(30) Foreign Application Priority Data
Aug. 9, 2024 (KR) 10-2024-0107037
Sep. 25, 2024 (KR) 10-2024-0130304

(51) Int. Cl. G06F 3/14; G06F 3/01

(52) U.S. Cl. CPC G06F 3/1454; G06F 3/013; G06F 3/017

(57) ABSTRACT

A wearable device is provided. The wearable device includes a display assembly including at least one display, communication circuitry, memory storing instructions, and at least one processor including processing circuitry, wherein the instructions, when executed by at least one processor individually or collectively, cause the wearable device to transmit, to an electronic device via the communication circuitry, mirroring data for a screen provided via the display assembly, while providing the mirroring data to the electronic device to display a screen according to the mirroring data on the electronic device, receive, from the electronic device via the communication circuitry, a message including images obtained via a camera of the electronic device, based on the images included in the message, identify a user input according to movement of an external object in the images, and display, via the display assembly, a visual object corresponding to the user input.

### CROSS-REFERENCE TO RELATED APPLICATION(S)

This application is a continuation application, claiming priority under 35 U.S.C. § 365(c), of an International application No. PCT/KR2025/006855, filed on May 20, 2025, which is based on and claims the benefit of a Korean patent application number 10-2024-0107037, filed on Aug. 9, 2024, in the Korean Intellectual Property Office, and of a Korean patent application number 10-2024-0130304, filed on Sep. 25, 2024, in the Korean Intellectual Property Office, the disclosure of each of which is incorporated by reference herein in its entirety.

### TECHNICAL FIELD

The disclosure relates to a wearable device, a method, and a non-transitory computer-readable storage media for recognizing data of an electronic device as an input.

### BACKGROUND ART

A wearable device may include a display and communication circuitry. The wearable device may be utilized as a tool for implementing virtual reality (VR), augmented reality (AR), and mixed reality (MR). The wearable device may display a three-dimensional space on the display. The wearable device may stream the three-dimensional space to an electronic device by transmitting data on the three-dimensional space to the electronic device via the communication circuitry.

The above information is presented as background information only to assist with an understanding of the disclosure. No determination has been made, and no assertion is made as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a wearable device, method, and non-transitory computer-readable storage media for recognizing data of electronic device as input.

Additional aspects will be set forth in part in the description which follows and, in part, will be apparent from the description, or may be learned by practice of the presented embodiments.

In accordance with an aspect of the disclosure, a wearable device is provided. The wearable device includes a display assembly including at least one display, communication circuitry, memory including one or more storage media and storing instructions, and at least one processor including processing circuitry. The instructions, when executed by the at least one processor individually or collectively, may cause the wearable device to transmit, to an electronic device via the communication circuitry, mirroring data for a screen representing at least a portion of a three-dimensional space provided via the display assembly, while providing the mirroring data to the electronic device to display a screen according to the mirroring data on the electronic device, receive, from the electronic device via the communication circuitry, a message including images obtained via a camera of the electronic device, based on the images included in the message, identify a user input according to movement of an external object in the images, and display, via the display assembly, a visual object corresponding to the user input.

In accordance with another aspect of the disclosure, a method performed by a wearable device including communication circuitry and a display assembly including at least one display, is provided. The method includes transmitting, to an electronic device via the communication circuitry, mirroring data for a screen representing at least a portion of a three-dimensional space provided via the display assembly, while providing the mirroring data to the electronic device to display a screen according to the mirroring data on the electronic device, receiving, from the electronic device via the communication circuitry, a message including images obtained via a camera of the electronic device, based on the images included in the message, identifying a user input according to movement of an external object in the images, and displaying, via the display assembly, a visual object corresponding to the user input.

In accordance with another aspect of the disclosure, one or more non-transitory computer-readable storage media storing one or more computer programs including computer-executable instructions that, when executed by one or more processors of a wearable device individually or collectively, cause the wearable device to perform operations are provided. The operations include transmitting, to an electronic device via communication circuitry of the wearable device, mirroring data for a screen representing at least a portion of a three-dimensional space provided via a display assembly of the wearable device, while providing the mirroring data to the electronic device to display a screen according to the mirroring data on the electronic device, receiving, from the electronic device via the communication circuitry, a message including images obtained via a camera of the electronic device, based on the images included in the message, identifying a user input according to movement of an external object in the images, and displaying, via the display assembly, a visual object corresponding to the user input.

In accordance with another aspect of the disclosure, an electronic device is provided. The electronic device includes a display, a camera, communication circuitry, memory including one or more storage media and storing instructions, and at least one processor including processing circuitry. The instructions, when executed by the at least one processor individually or collectively, may cause the electronic device to receive, from a wearable device via the communication circuitry, mirroring data for a screen displayed on the wearable device, display, via the display, a screen according to the mirroring data received from the wearable device, while the screen for the mirroring data is displayed on the display of the electronic device, obtain, via the camera, images including an external object, and transmit, to the wearable device via the communication circuitry, a message including the images, and wherein the images included in the message are used by the wearable device to display a visual object based on the images.

In accordance with another aspect of the disclosure, a method performed by an electronic device is provided. The method includes receiving, from a wearable device via communication circuitry of the electronic device, mirroring data for a screen displayed on the wearable device, displaying, via a display of the electronic device, a screen according to the mirroring data received from the wearable device, while the screen for the mirroring data is displayed on the display of the electronic device, obtaining, via a camera of the electronic device, images including an external object, and transmitting, to the wearable device via the communication circuitry, a message including the images, wherein the images included in the message are used by the wearable device to display a visual object based on the images.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, from a wearable device via communication circuitry of the electronic device, mirroring data for a screen displayed on the wearable device, displaying the screen according to the mirroring data received from the wearable device, while the screen for the mirroring data is displayed on a display of the electronic device, obtain, via a camera of the electronic device, images including an external object, and transmitting, to the wearable device via the communication circuitry, a message including the images, wherein the images included in the message are used by the wearable device to display a visual object based on the images.

In accordance with another aspect of the disclosure, a wearable device is provided. The wearable device includes a display assembly including at least one display, communication circuitry, memory including one or more storage media and storing instructions, and at least one processor including processing circuitry. The instructions, when executed by the at least one processor individually or collectively, may cause the wearable device to transmit, to an electronic device via the communication circuitry, mirroring data for a screen representing at least a portion of a three-dimensional space provided via the display assembly, while providing the mirroring data to the electronic device to display the screen according to the mirroring data on the electronic device, receive, from the electronic device via the communication circuitry, a message including a control command, and execute a function according to the control command included in the message, and wherein the message indicates that the control command corresponds to a user input obtained via a camera of the electronic device.

In accordance with another aspect of the disclosure, a method performed by a wearable device is provided. The method includes transmitting, to an electronic device via communication circuitry of the wearable device, mirroring data for a screen representing at least a portion of a three-dimensional space provided via a display assembly of the wearable device, while providing the mirroring data to the electronic device to display the screen according to the mirroring data on the electronic device, receiving, from the electronic device via the communication circuitry, a message including a control command, and executing a function according to the control command included in the message, and wherein the message indicates that the control command corresponds to a user input obtained via a camera of the electronic device.

In accordance with another aspect of the disclosure, one or more non-transitory computer-readable storage media storing one or more computer programs including computer-executable instructions that, when executed by one or more processors of a wearable device individually or collectively, cause the wearable device to perform operations are provided. The operations include transmitting, to an electronic device via communication circuitry of the wearable device, mirroring data for a screen representing at least a portion of a three-dimensional space provided via a display assembly of the wearable device, while providing the mirroring data to the electronic device to display the screen according to the mirroring data on the electronic device, receiving, from the electronic device via the communication circuitry, a message including a control command, and executing a function according to the control command included in the message, wherein the message indicates that the control command corresponds to a user input obtained via a camera of the electronic device.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to various embodiments of the disclosure;

FIG. 2A illustrates an example of a perspective view of a wearable device according to an embodiment of the disclosure;

FIG. 2B illustrates an example of one or more hardware disposed in a wearable device according to an embodiment of the disclosure;

FIGS. 3A and 3B illustrate an example of an appearance of a wearable device according to various embodiments of the disclosure;

FIG. 4 illustrates an example of a block diagram of a wearable device according to an embodiment of the disclosure;

FIG. 5 illustrates an example of a block diagram of an electronic device for displaying an image in a virtual space according to an embodiment of the disclosure;

FIG. 6 illustrates an example of a structure of a plurality of layers according to an embodiment of the disclosure;

FIG. 7 illustrates an example of a guide mode of a wearable device displaying a visual object corresponding to data of an electronic device according to an embodiment of the disclosure;

FIG. 8 illustrates an example of a control mode of a wearable device executing a function corresponding to data of an electronic device according to an embodiment of the disclosure;

FIG. 9 illustrates an example of operations performed between a wearable device and an electronic device to display a visual object corresponding to data obtained from the electronic device on a display of the wearable device according to an embodiment of the disclosure;

FIG. 10 illustrates an example of capability negotiation performed between a wearable device and an electronic device according to an embodiment of the disclosure;

FIG. 11 illustrates an example of a message transmitted from an electronic device according to an embodiment of the disclosure; and

FIG. 12 illustrates an example of operations of a wearable device executing a function according to a control command of an electronic device according to an embodiment of the disclosure.

Throughout the drawings, like reference numerals will be understood to refer to like parts, components, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms used in the disclosure are used only to describe a specific embodiment, and may not be intended to limit a range of another embodiment. A singular expression may include a plural expression unless the context clearly means otherwise. Terms used herein, including a technical or a scientific term, may have the same meaning as those generally understood by a person with ordinary skill in the art described in the disclosure. Among the terms used in the disclosure, terms defined in a general dictionary may be interpreted as identical or similar meaning to the contextual meaning of the relevant technology and are not interpreted as ideal or excessively formal meaning unless explicitly defined in the disclosure. In some cases, even terms defined in the disclosure may not be interpreted to exclude embodiments of the disclosure.

In various embodiments of the disclosure described below, a hardware approach will be described as an example. However, since the various embodiments of the disclosure include technology that uses both hardware and software, the various embodiments of the disclosure do not exclude a software-based approach.

A term referring to data (e.g., data, information, a signal, a data packet, a message, mirroring data, movement data, external data, input data, or payload data), a term referring to instructions (e.g., a module, a service, a manager, an engine, an application, an app, a function, a department, a layer, or an application programming interface (API)), a term referring to a value (e.g., a threshold value, reference information, reference gesture information, a designated parameter, a value, an octet, a bit, or a parameter), a term for an calculation state (e.g., an operation, or a process), a term for a network entity, a term for a component of a device, and the like, that are used in the following description, are exemplified for convenience of description. Therefore, the disclosure is not limited to the terms described below, and another term having the same technical meaning may be used.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

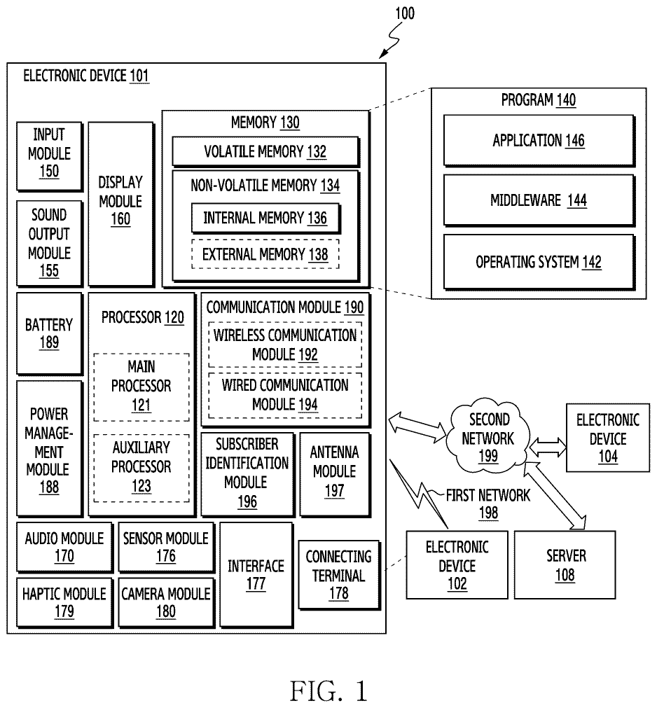

FIG. 1 is a block diagram illustrating an electronic device in a network environment according to various embodiments of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi™) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices (e.g., the electronic devices 102 the electronic devices 104 and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

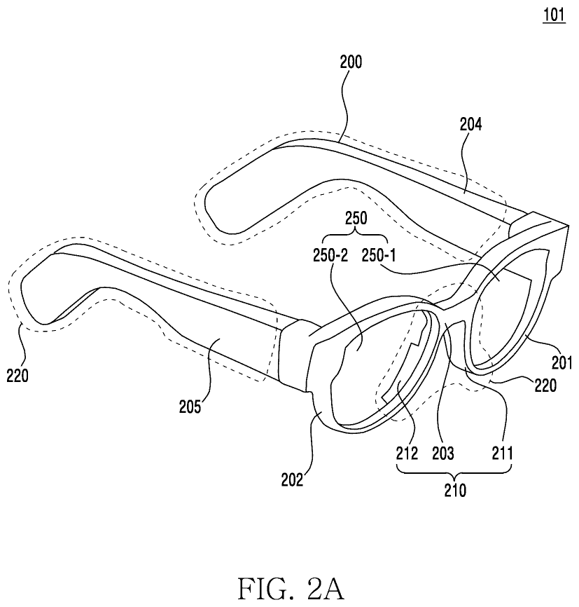

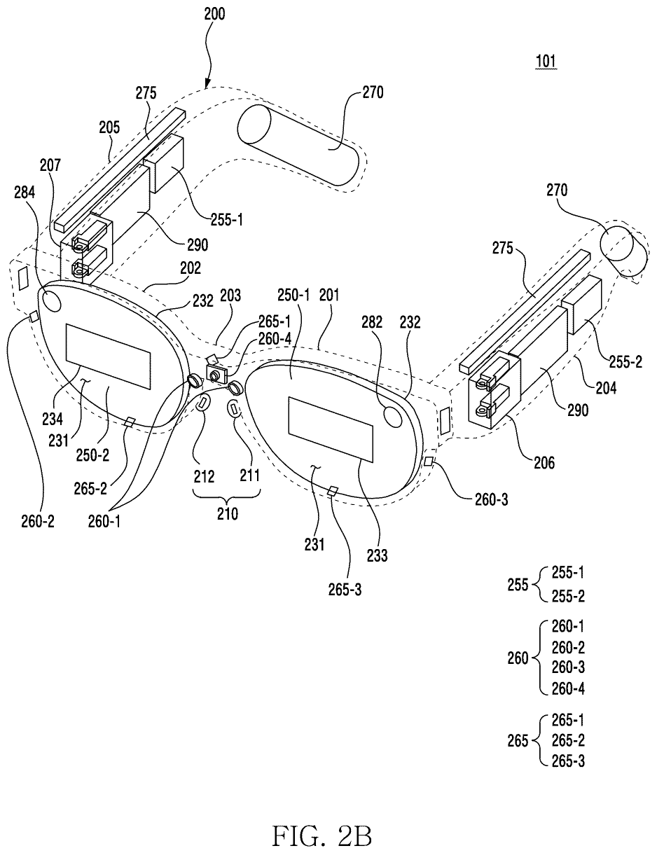

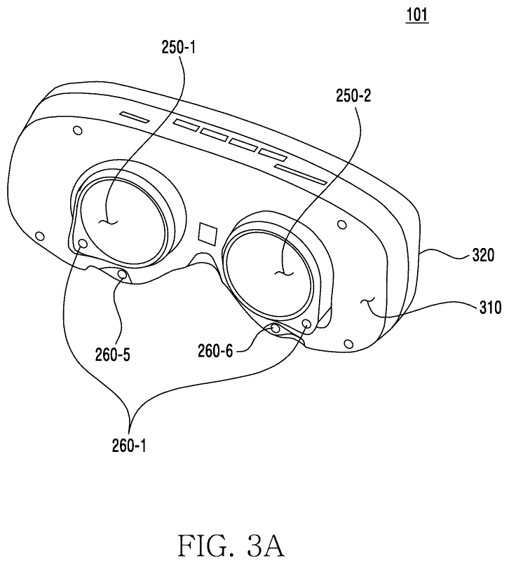

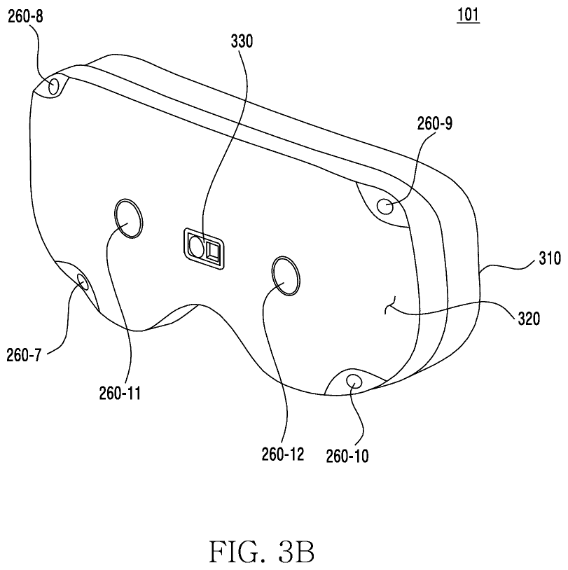

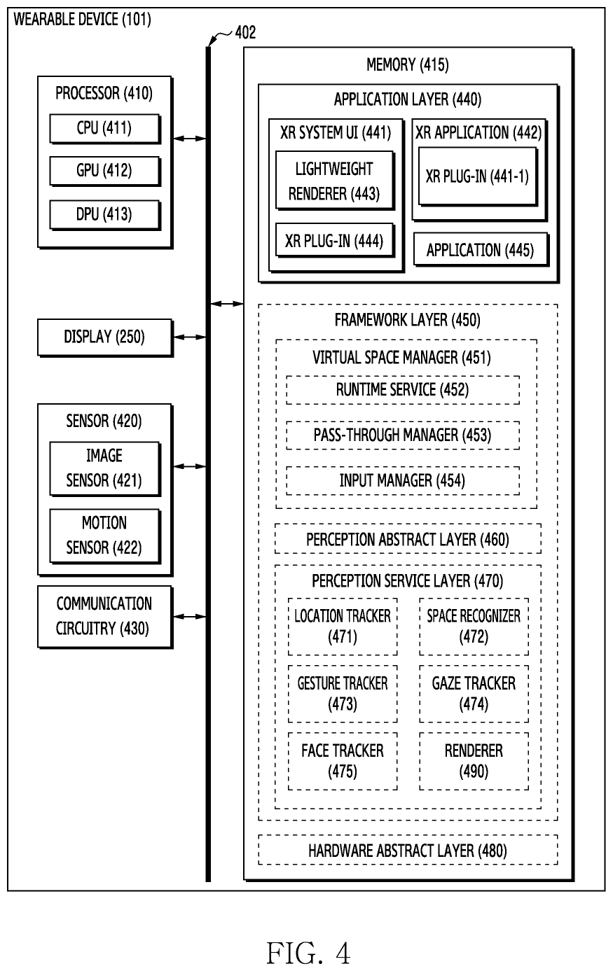

In embodiments of the disclosure, an electronic device (e.g., the electronic device 101 of FIG. 1) for displaying an image in a virtual space may be a wearable device. The electronic device 101 (e.g., the wearable device 101) may include a head-mounted display (HMD) wearable on a head of a user. The wearable device 101 may be referred as a head-mounted device (HMD), a headgear electronic device, a glasses-type electronic device, a video see-through or visible see-through (VST) device, an extended reality (XR) device, a virtual reality (VR) device and/or an augmented reality (AR) device. Although an appearance of the wearable device 101 having a form of glasses is illustrated, the embodiment is not limited thereto. An example of a hardware configuration included in the wearable device 101 is described with reference to FIG. 4. An example of a structure of the wearable device 101 wearable on the head of the user is described with reference to FIGS. 2A, 2B, 3A and/or 3B. The wearable device 101 may be referred to as an electronic device. For example, the electronic device may form the HMD by being coupled with an accessory (e.g., a strap) for being attached to the head of the user.

The wearable device 101 according to an embodiment may execute a function related to augmented reality (AR) and/or mixed reality (MR). For example, in a state in which the user is wearing the wearable device 101, the wearable device 101 may include at least one lens disposed adjacent to eyes of the user. The wearable device 101 may combine ambient light passing through the lens with light emitted from a display of the wearable device 101. A display area of the display may be formed within the lens through which the ambient light passes. Since the wearable device 101 combines the ambient light and the light emitted from the display, the user may see an image in which a real object recognized by the ambient light and a virtual object formed by the light emitted from the display are mixed. The augmented reality, the mixed reality, and/or the virtual reality described above may be referred to as extended reality (XR).

The wearable device 101 according to an embodiment may execute a function related to the video see-through or the visible see-through (VST) and/or the virtual reality (VR). For example, in a state in which the user is wearing the wearable device 101, the wearable device 101 may include a housing that covers the eyes of the user. In the state, the wearable device 101 may include a display disposed on a first surface of the housing facing the eyes. The wearable device 101 may include a camera disposed on a second surface opposite to the first surface. Using the camera, the wearable device 101 may obtain an image and/or a video representing ambient light. The wearable device 101 may output the image and/or the video in the display disposed on the first surface to enable the user to recognize the ambient light via the display. A displaying area (or a displaying region) or an active area (or an active region) of the display disposed on the first surface may be formed by one or more pixels included in the display. The wearable device 101 may synthesize a virtual object with the image and/or video outputted via the display to enable the user to recognize the virtual object together with the real object recognized by the ambient light.

The wearable device 101 according to an embodiment may identify or recognize a position (or a location) and/or a direction (or an orientation) of the wearable device 101 based on the image (and/or the video) obtained (or acquired) by using the camera. The wearable device 101 may obtain information on the external space by using one or more cameras and/or one or more sensors. The information may include a geographic location (e.g., a global positioning system (GPS) coordinate) of an external space identified from the one or more sensors. The information may include an image and/or a video of an external space identified from the one or more cameras. The wearable device 101 may identify external objects included in the external space from the image and/or the video by performing object recognition with respect to the image and/or the video.

Hereinafter, an example of a hardware configuration of the wearable device 101 will be described with reference to FIGS. 2A, 2B, 3A, 3B, and 4.

FIG. 2A illustrates an example of a perspective view of a wearable device according to an embodiment of the disclosure. FIG. 2B illustrates an example of one or more hardware disposed in the wearable device according to an embodiment of the disclosure. A wearable device 101 according to an embodiment may have a shape of glasses that are wearable on a body part (e.g., a head) of the user. The wearable device 101 of FIGS. 2A and 2B may be an example of the electronic device 101 of FIG. 1. The wearable device 101 may include a head-mounted display (HMD). For example, a housing of the wearable device 101 may include a flexible material such as rubber and/or silicone, having a shape that is in close contact with a portion (e.g., a portion of a face surrounding both eyes) of the head of the user. For example, the housing of the wearable device 101 may include one or more straps that is able to be twined around the head of the user and/or one or more temples attachable to an ear of the head.

Referring to FIG. 2A, according to an embodiment, a wearable device 101 may include at least one display 250 and a frame 200 supporting the at least one display 250.

According to an embodiment, the wearable device 101 may be wearable on a portion of the user's body. The wearable device 101 may provide augmented reality (AR), virtual reality (VR), or mixed reality (MR) combining the augmented reality and the virtual reality to a user wearing the wearable device 101. For example, the wearable device 101 may display a virtual reality image provided from at least one optical device 282 and 284 of FIG. 2B on at least one display 250, in response to a user's preset gesture obtained through a motion recognition camera 260-2 and 260-3 of FIG. 2B.

According to an embodiment, the at least one display 250 may provide visual information to a user. For example, the at least one display 250 may include a transparent or translucent lens. The at least one display 250 may include a first display 250-1 and/or a second display 250-2 spaced apart from the first display 250-1. For example, the first display 250-1 and the second display 250-2 may be disposed at positions corresponding to the user's left and right eyes, respectively.

Referring to FIG. 2B, at least one display 250 may provide visual information transmitted through a lens included in the at least one display 250 from ambient light to a user and other visual information distinguished from the visual information. The lens may be formed based on at least one of a fresnel lens, a pancake lens, or a multi-channel lens. For example, the at least one display 250 may include a first surface 231 and a second surface 232 opposite to the first surface 231. A display area may be formed on the second surface 232 of at least one display 250. When the user wears the wearable device 101, ambient light may be transmitted to the user by being incident on the first surface 231 and being penetrated through the second surface 232. For another example, the at least one display 250 may display an augmented reality image in which a virtual reality image provided by the at least one optical device 282 and 284 is combined with a reality screen transmitted through ambient light, on a display area formed on the second surface 232.

In an embodiment, the at least one display 250 may include at least one waveguide 233 and 234 that transmits light transmitted from the at least one optical device 282 and 284 by diffracting to the user. The at least one waveguide 233 and 234 may be formed based on at least one of glass, plastic, or polymer. A nano pattern may be formed on at least a portion of the outside or inside of the at least one waveguide 233 and 234. The nano pattern may be formed based on a grating structure having a polygonal or curved shape. Light incident to an end of the at least one waveguide 233 and 234 may be propagated to another end of the at least one waveguide 233 and 234 by the nano pattern. The at least one waveguide 233 and 234 may include at least one of at least one diffraction element (e.g., a diffractive optical element (DOE), a holographic optical element (HOE)), and a reflection element (e.g., a reflection mirror). For example, the at least one waveguide 233 and 234 may be disposed in the wearable device 101 to guide a screen displayed by the at least one display 250 to the user's eyes. For example, the screen may be transmitted to the user's eyes based on total internal reflection (TIR) generated in the at least one waveguide 233 and 234.

The wearable device 101 may analyze an object included in a real image collected through a photographing camera 260-4, combine with a virtual object corresponding to an object that become a subject of augmented reality provision among the analyzed object, and display on the at least one display 250. The virtual object may include at least one of text and images for various information associated with the object included in the real image. The wearable device 101 may analyze the object based on a multi-camera such as a stereo camera. For the object analysis, the wearable device 101 may execute space recognition (e.g., simultaneous localization and mapping (SLAM)) using the multi-camera and/or time-of-flight (ToF). The user wearing the wearable device 101 may watch an image displayed on the at least one display 250.

According to an embodiment, the frame 200 may be configured with a physical structure in which the wearable device 101 may be worn on the user's body. According to an embodiment, the frame 200 may be configured so that when the user wears the wearable device 101, the first display 250-1 and the second display 250-2 may be positioned corresponding to the user's left and right eyes. The frame 200 may support the at least one display 250. For example, the frame 200 may support the first display 250-1 and the second display 250-2 to be positioned at positions corresponding to the user's left and right eyes.

Referring to FIG. 2A, according to an embodiment, the frame 200 may include an area 220 at least partially in contact with the portion of the user's body in case that the user wears the wearable device 101. For example, the area 220 of the frame 200 in contact with the portion of the user's body may include an area in contact with a portion of the user's nose, a portion of the user's ear, and a portion of the side of the user's face that the wearable device 101 contacts. According to an embodiment, the frame 200 may include a nose pad 210 that is contacted on the portion of the user's body. When the wearable device 101 is worn by the user, the nose pad 210 may be contacted on the portion of the user's nose. The frame 200 may include a first temple 204 and a second temple 205, which are contacted on another portion of the user's body that is distinct from the portion of the user's body.

For example, the frame 200 may include a first rim 201 surrounding at least a portion of the first display 250-1, a second rim 202 surrounding at least a portion of the second display 250-2, a bridge 203 disposed between the first rim 201 and the second rim 202, a first pad 211 disposed along a portion of the edge of the first rim 201 from one end of the bridge 203, a second pad 212 disposed along a portion of the edge of the second rim 202 from the other end of the bridge 203, the first temple 204 extending from the first rim 201 and fixed to a portion of the wearer's ear, and the second temple 205 extending from the second rim 202 and fixed to a portion of the ear opposite to the ear. The first pad 211 and the second pad 212 may be in contact with the portion of the user's nose, and the first temple 204 and the second temple 205 may be in contact with a portion of the user's face and the portion of the user's ear. The temples 204 and 205 may be rotatably connected to the rim through hinge units 206 and 207 of FIG. 2B. The first temple 204 may be rotatably connected with respect to the first rim 201 through a first hinge unit 206 disposed between the first rim 201 and the first temple 204. The second temple 205 may be rotatably connected with respect to the second rim 202 through a second hinge unit 207 disposed between the second rim 202 and the second temple 205. According to an embodiment, the wearable device 101 may identify an external object (e.g., a user's fingertip) touching the frame 200 and/or a gesture performed by the external object by using a touch sensor, a grip sensor, and/or a proximity sensor formed on at least a portion of the surface of the frame 200.

According to an embodiment, the wearable device 101 may include hardware (e.g., hardware described above based on the block diagram of FIG. 2) that performs various functions. For example, the hardware may include a battery module 270, an antenna module 275, the at least one optical device 282 and 284, speakers (e.g., speakers 255-1 and 255-2), a microphone (e.g., microphones 265-1, 265-2, and 265-3), a light emitting module (not illustrated), and/or a printed circuit board (PCB) 290 (e.g., printed circuit board). Various hardware may be disposed in the frame 200.

According to an embodiment, the microphone (e.g., the microphones 265-1, 265-2, and 265-3) of the wearable device 101 may obtain a sound signal, by being disposed on at least a portion of the frame 200. A first microphone 265-1 disposed on the bridge 203, a second microphone 265-2 disposed on the second rim 202, and a third microphone 265-3 disposed on the first rim 201 are illustrated in FIG. 2B, but the number and disposition of microphone 265 are not limited to an embodiment of FIG. 2B. In case that the number of the microphone 265 included in the wearable device 101 is two or more, the wearable device 101 may identify a direction of the sound signal by using a plurality of microphones disposed on different portions of the frame 200.

According to an embodiment, the at least one optical device 282 and 284 may project a virtual object on the at least one display 250 in order to provide various image information to the user. For example, the at least one optical device 282 and 284 may be a projector. The at least one optical device 282 and 284 may be disposed adjacent to the at least one display 250 or may be included in the at least one display 250 as a portion of the at least one display 250. According to an embodiment, the wearable device 101 may include a first optical device 282 corresponding to the first display 250-1, and a second optical device 284 corresponding to the second display 250-2. For example, the at least one optical device 282 and 284 may include the first optical device 282 disposed at a periphery of the first display 250-1 and the second optical device 284 disposed at a periphery of the second display 250-2. The first optical device 282 may transmit light to a first waveguide 233 disposed on the first display 250-1, and the second optical device 284 may transmit light to a second waveguide 234 disposed on the second display 250-2.

In an embodiment, a camera 260 may include the photographing camera 260-4, an eye tracking camera (ET CAM) 260-1, and/or the motion recognition camera 260-2 and 260-3. The photographing camera 260-4, the eye tracking camera 260-1, and the motion recognition camera 260-2 and 260-3 may be disposed at different positions on the frame 200 and may perform different functions. The eye tracking camera 260-1 may output data indicating a position of eye or a gaze of the user wearing the wearable device 101. For example, the wearable device 101 may detect the gaze from an image including the user's pupil obtained through the eye tracking camera 260-1. The wearable device 101 may identify an object (e.g., a real object, and/or a virtual object) focused by the user, by using the user's gaze obtained through the eye tracking camera 260-1. The wearable device 101 identifying the focused object may execute a function (e.g., gaze interaction) for interaction between the user and the focused object. The wearable device 101 may represent a portion corresponding to eye of an avatar indicating the user in the virtual space, by using the user's gaze obtained through the eye tracking camera 260-1. The wearable device 101 may render an image (or a screen) displayed on the at least one display 250, based on the position of the user's eye. For example, visual quality (e.g., resolution, brightness, saturation, grayscale, and pixels per inch (PPI)) of a first area related to the gaze within the image and visual quality of a second area distinguished from the first area may be different. In this disclosure, the term “resolution” is used to refer to the density of pixels in an image and/or display 250. The density and/or resolution of pixels may be measured based on a unit of PPI and/or dot performance (dpi), or may be parameterized. The wearable device 101 may obtain an image having the visual quality of the first area matching the user's gaze and the visual quality of the second area by using foveated rendering. For example, when the wearable device 101 supports an iris recognition function, user authentication may be performed based on iris information obtained using the eye tracking camera 260-1. An example in which the eye tracking camera 260-1 is disposed toward the user's right eye is illustrated in FIG. 2B, but the embodiment is not limited thereto, and the eye tracking camera 260-1 may be disposed alone toward the user's left eye or may be disposed toward two eyes.

In an embodiment, the photographing camera 260-4 may photograph a real image or background to be matched with a virtual image in order to implement the augmented reality or mixed reality content. The photographing camera 260-4 may be used to obtain an image having a high resolution based on a high resolution (HR) or a photo video (PV). The photographing camera 260-4 may photograph an image of a specific object existing at a position viewed by the user and may provide the image to the at least one display 250. The at least one display 250 may display one image in which a virtual image provided through the at least one optical device 282 and 284 is overlapped with information on the real image or background including an image of the specific object obtained by using the photographing camera 260-4. The wearable device 101 may compensate for depth information (e.g., a distance between the wearable device 101 and an external object obtained through a depth sensor), by using an image obtained through the photographing camera 260-4. The wearable device 101 may perform object recognition through an image obtained using the photographing camera 260-4. The wearable device 101 may perform a function (e.g., auto focus) of focusing an object (or subject) within an image and/or an optical image stabilization (OIS) function (e.g., an anti-shaking function) by using the photographing camera 260-4. While displaying a screen representing a virtual space on the at least one display 250, the wearable device 101 may perform a pass through function for displaying an image obtained through the photographing camera 260-4 overlapping at least a portion of the screen. In an embodiment, the photographing camera 260-4 may be disposed on the bridge 203 disposed between the first rim 201 and the second rim 202.

The eye tracking camera 260-1 may implement a more realistic augmented reality by matching the user's gaze with the visual information provided on the at least one display 250, by tracking the gaze of the user wearing the wearable device 101. For example, when the user looks at the front, the wearable device 101 may naturally display environment information associated with the user's front on the at least one display 250 at a position where the user is positioned. The eye tracking camera 260-1 may be configured to capture an image of the user's pupil in order to determine the user's gaze. For example, the eye tracking camera 260-1 may receive gaze detection light reflected from the user's pupil and may track the user's gaze based on the position and movement of the received gaze detection light. In an embodiment, the eye tracking camera 260-1 may be disposed at a position corresponding to the user's left and right eyes. For example, the eye tracking camera 260-1 may be disposed in the first rim 201 and/or the second rim 202 to face the direction in which the user wearing the wearable device 101 is positioned.

The motion recognition camera 260-2 and 260-3 may provide a specific event to the screen provided on the at least one display 250 by recognizing the movement of the whole or portion of the user's body, such as the user's torso, hand, or face. The motion recognition camera 260-2 and 260-3 may obtain a signal corresponding to motion by recognizing the user's motion (e.g., gesture recognition), and may provide a display corresponding to the signal to the at least one display 250. The processor may identify a signal corresponding to the operation and may perform a preset function based on the identification. The motion recognition camera 260-2 and 260-3 may be used to perform simultaneous localization and mapping (SLAM) for 6 degrees of freedom pose (6 dof pose) and/or a space recognition function using a depth map. The processor may perform a gesture recognition function and/or an object tracking function, by using the motion recognition camera 260-2 and 260-3. In an embodiment, the motion recognition camera 260-2 and 260-3 may be disposed on the first rim 201 and/or the second rim 202.

The camera 260 included in the wearable device 101 is not limited to the above-described eye tracking camera 260-1 and the motion recognition camera 260-2 and 260-3. For example, the wearable device 101 may identify an external object included in a field of view (FoV) by using a camera disposed toward the user's FoV. The wearable device 101 identifying the external object may be performed based on a sensor for identifying a distance between the wearable device 101 and the external object, such as a depth sensor and/or a time of flight (ToF) sensor. The camera 260 disposed toward the FoV may support an autofocus function (AF) and/or an optical image stabilization (OIS) function. For example, in order to obtain an image including a face of the user wearing the wearable device 101, the wearable device 101 may include the camera 260 (e.g., a face tracking (FT) camera) disposed toward the face.

Although not illustrated, the wearable device 101 according to an embodiment may further include a light source (e.g., LED) that emits light toward a subject (e.g., user's eyes, face, and/or an external object in the FoV) photographed by using the camera 260. The light source may include an LED having an infrared wavelength. The light source may be disposed on at least one of the frame 200, and the hinge units 206 and 207.

According to an embodiment, the battery module 270 may supply power to electronic components of the wearable device 101. In an embodiment, the battery module 270 may be disposed in the first temple 204 and/or the second temple 205. For example, the battery module 270 may be a plurality of battery modules 270. The plurality of battery modules 270, respectively, may be disposed on each of the first temple 204 and the second temple 205. In an embodiment, the battery module 270 may be disposed at an end of the first temple 204 and/or the second temple 205.

The antenna module 275 may transmit the signal or power to the outside of the wearable device 101 or may receive the signal or power from the outside. In an embodiment, the antenna module 275 may be disposed in the first temple 204 and/or the second temple 205. For example, the antenna module 275 may be disposed close to one surface of the first temple 204 and/or the second temple 205.

A speaker 255 may output a sound signal to the outside of the wearable device 101. A sound output module may be referred to as a speaker. In an embodiment, the speaker 255 may be disposed in the first temple 204 and/or the second temple 205 in order to be disposed adjacent to the ear of the user wearing the wearable device 101. For example, the speaker 255 may include a second speaker 255-2 disposed adjacent to the user's left ear by being disposed in the first temple 204, and a first speaker 255-1 disposed adjacent to the user's right ear by being disposed in the second temple 205.

The light emitting module (not illustrated) may include at least one light emitting element. The light emitting module may emit light of a color corresponding to a specific state or may emit light through an operation corresponding to the specific state in order to visually provide information on a specific state of the wearable device 101 to the user. For example, when the wearable device 101 requires charging, it may emit red light at a constant cycle. In an embodiment, the light emitting module may be disposed on the first rim 201 and/or the second rim 202.

Referring to FIG. 2B, according to an embodiment, a wearable device 101 may include a printed circuit board (PCB) 290. The PCB 290 may be included in at least one of a first temple 204 or a second temple 205. The PCB 290 may include an interposer disposed between at least two sub PCBs. On the PCB 290, one or more hardware (e.g., hardware illustrated by blocks of FIG. 4) included in the wearable device 101 may be disposed. The wearable device 101 may include a flexible PCB (FPCB) for interconnecting the hardware.

According to an embodiment, the wearable device 101 may include at least one of a gyro sensor, a gravity sensor, and/or an acceleration sensor for detecting the posture of the wearable device 101 and/or the posture of a body part (e.g., a head) of the user wearing the wearable device 101. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment, the wearable device 101 may identify the user's motion and/or gesture performed to execute or stop a specific function of the wearable device 101 based on the IMU.

FIGS. 3A and 3B illustrate an example of an exterior of a wearable device (e.g., the wearable device 101 of FIGS. 2A and 2B) according to various embodiments of the disclosure. The wearable device 101 of FIGS. 3A and 3B may be an example of the electronic device 101 of FIG. 1, the wearable device 101 of FIGS. 2A and 2B. According to an embodiment, an example of an exterior of a first surface 310 of a housing of the wearable device 101 may be illustrated in FIG. 3A, and an example of an exterior of a second surface 320 opposite to the first surface 310 may be illustrated in FIG. 3B.

Referring to FIG. 3A, according to an embodiment, a first surface 310 of a wearable device 101 may have an attachable shape on the user's body part (e.g., the user's face). Although not illustrated, the wearable device 101 may further include a strap for being fixed on the user's body part, and/or one or more temples (e.g., the first temple 204 and/or the second temple 205 of FIGS. 2A and 2B). A first display 250-1 for outputting an image to the left eye among the user's two eyes and a second display 250-2 for outputting an image to the right eye among the user's two eyes may be disposed on the first surface 310. The wearable device 101 may further include rubber or silicon packing, which are formed on the first surface 310, for preventing interference by light (e.g., ambient light) different from the light emitted from the first display 250-1 and the second display 250-2.

According to an embodiment, the wearable device 101 may include cameras 260-1 for photographing and/or tracking two eyes of the user adjacent to each of the first display 250-1 and the second display 250-2. The cameras 260-1 may be referred to as a gaze tracking camera or the eye tracking camera 260-1 of FIG. 2B. According to an embodiment, the wearable device 101 may include cameras 260-5 and 260-6 for photographing and/or recognizing the user's face. The cameras 260-5 and 260-6 may be referred to as an FT camera. The wearable device 101 may control an avatar representing a user in a virtual space, based on a motion of the user's face identified using the cameras 260-5 and 260-6. For example, the wearable device 101 may change a texture and/or a shape of a portion (e.g., a portion of an avatar representing a human face) of the avatar, by using information obtained by the cameras 260-5 and 260-6 (e.g., the FT camera) and representing the facial expression of the user wearing the wearable device 101.

Referring to FIG. 3B, a camera (e.g., cameras 260-7, 260-8, 260-9, 260-10, 260-11, and 260-12), and/or a sensor (e.g., a depth sensor 330) for obtaining information associated with the external environment of the wearable device 101 may be disposed on the second surface 320 opposite to the first surface 310 of FIG. 3A. For example, the cameras 260-7, 260-8, 260-9, and 260-10 may be disposed on the second surface 320 in order to recognize an external object. The cameras 260-7, 260-8, 260-9, and 260-10 may be referred to as the motion recognition cameras 260-2 and 260-3 of FIG. 2B.

By using cameras 260-11 and 260-12, the wearable device 101 may obtain an image and/or video to be transmitted to each of the user's two eyes. The camera 260-11 may be disposed on the second surface 320 of the wearable device 101 to obtain an image to be displayed through the second display 250-2 corresponding to the right eye among the two eyes. The camera 260-12 may be disposed on the second surface 320 of the wearable device 101 to obtain an image to be displayed through the first display 250-1 corresponding to the left eye among the two eyes. The cameras 260-11 and 260-12 may be referred to as the photographing camera 260-4 of FIG. 2B.

According to an embodiment, the wearable device 101 may include the depth sensor 330 disposed on the second surface 320 in order to identify a distance between the wearable device 101 and the external object. By using the depth sensor 330, the wearable device 101 may obtain spatial information (e.g., a depth map) about at least a portion of the FoV of the user wearing the wearable device 101. Although not illustrated, a microphone for obtaining sound outputted from the external object may be disposed on the second surface 320 of the wearable device 101. The number of microphones may be one or more according to embodiments.

Hereinafter, a hardware or software configuration of the wearable device 101 will be described later with reference to FIG. 4.

FIG. 4 illustrates an example of a block diagram of a wearable device (e.g., the wearable device 101 of FIGS. 2A and 2B) according to an embodiment of the disclosure. The wearable device 101 of FIG. 4 may be an example of the electronic device 101 of FIG. 1 and the wearable device 101 of FIGS. 2A to 3B.

Referring to FIG. 4, a wearable device 101 according to an embodiment may include a processor 410, memory 415, a display 250 (e.g., the first display 250-1 and/or the second display 250-2 of FIGS. 2A, 2B, 3A, and 3B) and/or a sensor 420 (e.g., an image sensor 421 and/or a motion sensor 422) and/or communication circuitry 430 (e.g., including at least a portion of the communication module 190 of FIG. 1). The processor 410, the memory 415, the display 250, the sensor 420, and/or the communication circuitry 430 may be electrically and/or operably connected to each other by an electronic component such as a communication bus 402. In the disclosure, an operational connection of electronic components may include a direct connection established between the electronic components and/or an indirect connection established between the electronic components such that a first electronic component of the electronic components is controlled by a second electronic component of the electronic components. The type and/or number of electronic components included in the wearable device 101 is not limited as illustrated in FIG. 4. For example, the wearable device 101 may include only some of the electronic components illustrated in FIG. 4.

According to an embodiment, the processor 410 of the wearable device 101 may include circuitry (e.g., processing circuitry) for processing data, based on one or more instructions. For example, the circuitry for processing data may include an arithmetic and logic unit (ALU), a field programmable gate array (FPGA), a central processing unit (CPU) and/or an application processor (AP). In an embodiment, the wearable device 101 may include one or more processors. According to an embodiment, a structure of the processor 410 is not limited to an embodiment of the disclosure, and at least one circuit may be formed as a separate processor physically separated outside the processor. The processor 410 may have a structure of a multi-core processor such as a dual core, a quad core, a hexa core, and/or an octa core. The multi-core processor structure of the processor 410 may include a structure (e.g., a big-little structure) based on a plurality of core circuits, divided by power consumption, clock, and/or computational amount per unit time. In an embodiment including the processor 410 having a multi-core processor structure, operations and/or functions of the disclosure may be performed individually or collectively by one or more cores included in the processor 410.

According to an embodiment, the memory 415 of the wearable device 101 may include an electronic component for storing data and/or instructions inputted to the processor 410 and/or outputted from the processor 410. For example, the memory 415 may include volatile memory such as random-access memory (RAM) and/or non-volatile memory such as read-only memory (ROM). For example, the volatile memory may include at least one of a dynamic RAM (DRAM), a static RAM (SRAM), a cache RAM, and a pseudo SRAM (PSRAM). For example, the non-volatile memory may include at least one of a programmable ROM (PROM), an erasable PROM (EPROM), an electrically erasable PROM (EEPROM), flash memory, a hard disk, a compact disc, and an embedded multi-media card (eMMC). In an embodiment, the memory 415 may be referred to as a storage.

In an embodiment, the display 250 of the wearable device 101 may output visualized information to a user of the wearable device 101. The display 250 arranged in front of eyes of the user wearing the wearable device 101 may be disposed in at least a portion of a housing of the wearable device 101 (e.g., the first display 250-1 and/or the second display 250-2 of FIGS. 2A, 2B, 3A, and 3B). For example, the display 250 may be included in the display assembly. For example, the display 250 may output visualized information to the user by being controlled by the processor 410 including a circuit such as a CPU 411, a graphics processing unit (GPU) 412, and/or a display processing unit (DPU) 413. The display 250 may include a flexible display, a flat panel display (FPD) and/or electronic paper. The display 250 may include a liquid crystal display (LCD), a plasma display panel (PDP), and/or one or more light emitting diode (LED). The LED may include an organic LED (OLED). The embodiment is not limited thereto, and for example, the display 250 may include a projector (or projection assembly) for projecting light onto the lens when the wearable device 101 includes a lens for transmitting external light (or ambient light). In an embodiment, the display 250 may be referred to as a display panel and/or a display module. Pixels included in the display 250 may be disposed toward any one of the user's two eyes when worn by the user of the wearable device 101. For example, the display 250 may include display areas (or active areas) corresponding to each of the user's two eyes.

In an embodiment, the sensor 420 of the wearable device 101 may generate electronic information capable of being processed by the processor 410 and/or the memory 415 from non-electronic information associated with the wearable device 101. For example, the sensor 420 may include a global positioning system (GPS) sensor for detecting a geographic location of the wearable device 101. In addition to the GPS method, the sensor 420 may generate information indicating a geographical location of the wearable device 101 based on a global navigation satellite system (GNSS), such as Galileo, Beidou, or Compass). The information may be stored in the memory 415, processed by the processor 410, and/or transmitted to another electronic device distinct from the wearable device 101 via a communication circuit.

Referring to FIG. 4, as an example of the sensor 420 included in the wearable device 101, the image sensor 421 and/or the motion sensor 422 are illustrated. The sensor 420 may include one or more optical sensors (e.g., a charged coupled device (CCD) sensor and a complementary metal oxide semiconductor (CMOS) sensor) that generate an electrical signal indicating a color and/or brightness of light. The image sensor 421 may be referred to as a camera. The plurality of optical sensors included in the image sensor 421 may be disposed in a form of a 2-dimensional array. The image sensor 421 may substantially simultaneously obtain electrical signals of each of the plurality of optical sensors to generate 2-dimensional frame data corresponding to light reaching optical sensors of the 2-dimensional array. For example, photographic data captured using the image sensor 421 may mean a 2-dimensional frame data obtained from the image sensor 421. For example, video data captured using the image sensor 421 may mean a sequence of the plurality of 2-dimensional frame data obtained from the image sensor 421 according to a frame rate. The image sensor 421 may further include a flash light, disposed toward a direction in which the image sensor 421 receives light and outputting light toward the direction.

According to an embodiment, the wearable device 101 may include a plurality of image sensors disposed in different directions, as an example of the image sensor 421. As described above with reference to FIGS. 2A, 2B, 3A, and 3B, the plurality of image sensors may include a gaze tracking camera (e.g., the eye tracking cameras 260-1 of FIGS. 2B and 3A) configured to be arranged toward eyes of a user wearing the wearable device 101. The plurality of image sensors may include an outward camera. The processor 410 may identify a direction of the user's gaze by using an image and/or a video obtained from the gaze tracking camera. The gaze tracking camera may include an infrared (IR) sensor. The gaze tracking camera may be referred to as an eye sensor and/or an eye tracker.

The outward camera may be disposed toward the front of the user wearing the wearable device 101 (e.g., a direction to which two eyes may be directed). The wearable device 101 may include a plurality of outward cameras. The embodiment is not limited thereto, and the outward camera may be disposed toward an external space. The processor 410 may identify an external object by using an image and/or a video obtained from the outward camera. For example, the processor 410 may identify a position, shape, and/or gesture (e.g., hand gesture) of a hand of the user wearing the wearable device 101, based on an image and/or a video obtained from the outward camera. Using an image and/or a video of the external environment, obtained from the outward camera, the processor 410 may recognize or track one or more objects in the external environment.

According to an embodiment, the motion sensor 422 may output an electric signal indicating gravitational acceleration, acceleration, and/or angular velocity of a plurality of axes (e.g., x-axis, y-axis, and z-axis), which are perpendicular to each other and based on an origin designated in the wearable device 101 and/or the motion sensor 422. For example, the processor 410 may repeatedly receive or obtain, from the motion sensor 422, sensor data including accelerations, angular velocities, and/or magnitudes of a magnetic field of the number of the plurality of axes, based on a designated period (e.g., 1 millisecond (ms)). In an embodiment, the motion sensor 422 may be referred to as an inertial measurement unit (IMU). The sensor 420 included in the wearable device 101 is not limited to the above description, and may include a grip sensor, a proximity sensor, a heart rate sensor, a fingerprint sensor, an illumination sensor, and/or a ToF sensor. Using the motion sensor 422, the processor 410 may detect motion of the wearable device 101 (e.g., motion of the wearable device 101 caused by the user wearing the wearable device 101).

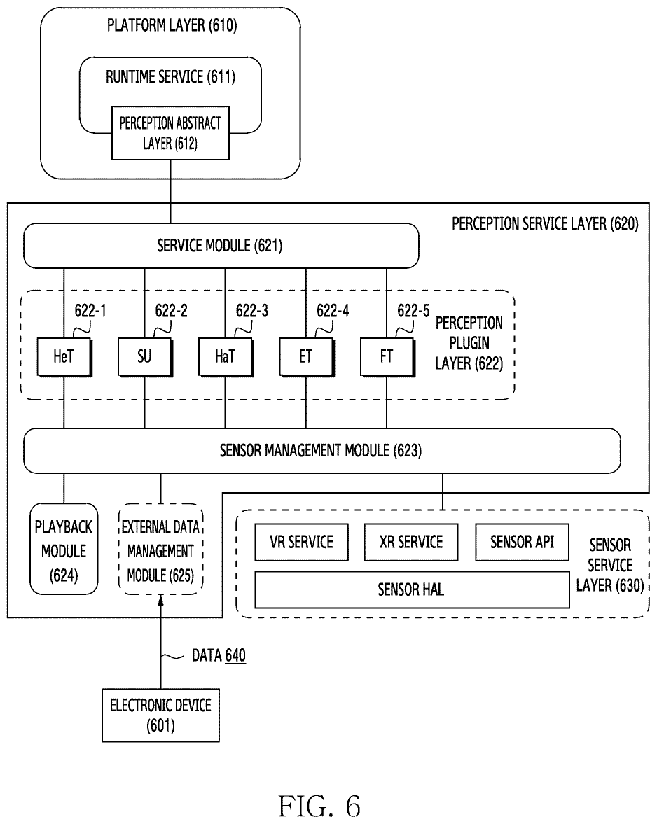

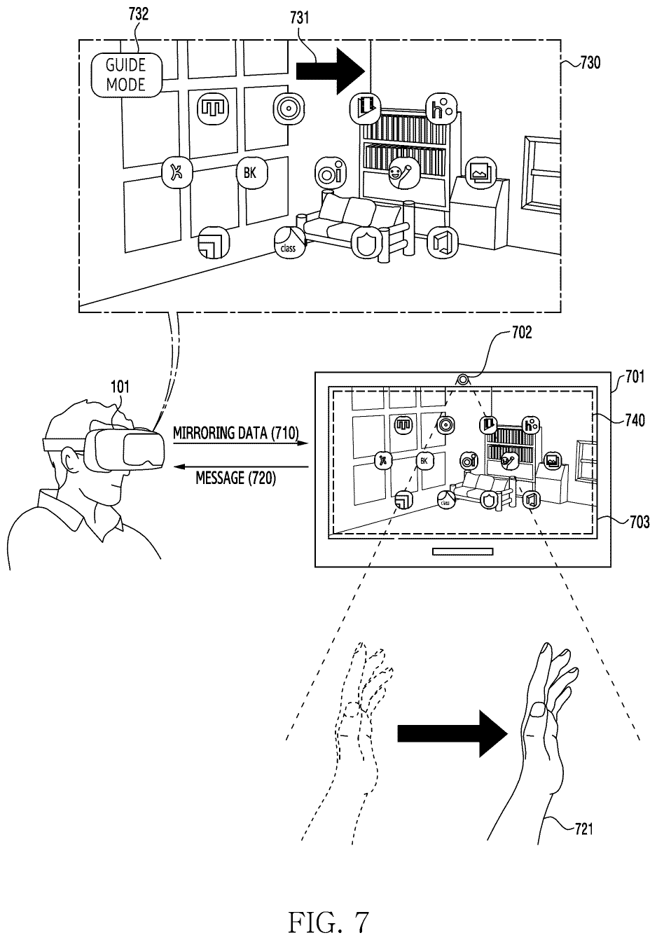

In an embodiment, the communication circuitry 430 of the wearable device 101 may include a hardware component for supporting transmission and/or reception of a signal between the wearable device 101 and an external electronic device (e.g., the electronic device 102, the electronic device 104, electronic device 601 of FIG. 6, and electronic device 701 of FIG. 7). For example, the communication circuitry 430 may include at least one of a modem, an antenna, and an optic/electronic (O/E) converter. The communication circuitry 430 may support transmission and/or reception of an electrical signal, based on various types of protocols such as Ethernet, local area network (LAN), wide area network (WAN), wireless fidelity (Wi-Fi™), Bluetooth™, Bluetooth™ low energy (BLE), Zigbee™, long term evolution (LTE), and 5G new radio (NR).

According to an embodiment, one or more instructions (or commands) indicating data to be processed by the processor 410 of the wearable device 101, calculations and/or operations to be performed may be stored in the memory 415 of the wearable device 101. A set of one or more instructions may be referred to as a program, firmware, operating system, process, routine, sub-routine, and/or software application (hereinafter referred to as application). For example, the wearable device 101 and/or the processor 410 may perform at least one of operations of FIGS. 6, 7, 8, 9, 10, 11 and 12, when a set of a plurality of instruction distributed in the form of an operating system, firmware, driver, program, and/or software application is executed. Hereinafter, a software application being installed within the wearable device 101 may mean that one or more instructions provided in the form of a software application (or package) are stored in the memory 415, and that the one or more applications are stored in an executable format (e.g., a file with an extension designated by the operating system of the wearable device 101) by the processor 410. As an example, the application may include a program and/or a library, associated with a service provided to a user.

Referring to FIG. 4, programs installed in the wearable device 101 may be included in any one among different layers including an application layer 440, a framework layer 450, and/or a hardware abstraction layer (HAL) S, based on a target. For example, programs (e.g., module or driver) designed to target a hardware (e.g., the display 250, and/or the sensor 420) of the wearable device 101 may be included in a hardware abstraction layer 480 (e.g., android system HAL, and/or XR HAL). In terms of including one or more programs for providing an extended reality (XR) service, the framework layer 450 may be referred to as an XR framework layer. For example, the layers illustrated in FIG. 4, which are logically separated (or for convenience of explanation), may not mean that an address space of the memory 415 is divided by the layers.

Programs (e.g., a location tracker 471, a space recognizer 472, a gesture tracker 473, a gaze tracker 474, a face tracker 475, and/or a renderer 490) designed to target at least one of the hardware abstraction layer 480 and/or the application layer 440 may be included within framework layer 450. Programs included in the framework layer 450 may provide an application programming interface (API) capable of being executed (or called) based on other programs.

A program designed to target a user of the wearable device 101 may be included in the application layer 440. An extended reality (XR) system user interface (UI) 441 and/or an XR application 442 are illustrated as an example of programs included in the application layer 440, but embodiments are not limited thereto. For example, programs (e.g., software application) included in the application layer 440 may cause execution of a function supported by programs included in the framework layer 450, by calling the API.

The wearable device 101 may display, on the display 250, one or more visual objects for performing interaction with the user, based on the execution of the XR system UI 441. The visual object may mean an object capable of being positioned within a screen for transmission of information and/or interaction, such as text, image, icon, video, button, check box, radio button, text box, slider and/or table. The visual object may be referred to as a visual guide, a virtual object, a visual element, a UI element, a view object, and/or a view element. The wearable device 101 may provide functions available in a virtual space to the user, based on the execution of the XR system UI 441.

Referring to FIG. 4, it is described that the XR system UI 441 includes a lightweight renderer 443 and/or an XR plug-in 444 but is not limited thereto. For example, a processor 410 may execute the lightweight renderer 443 and/or the XR plug-in 444 in the framework layer 450, based on the XR system UI 441.

The wearable device 101 may obtain a resource (e.g., API, system process, and/or library) used to define, create, and/or execute a rendering pipeline in which partial changes are allowed, based on the execution of the lightweight renderer 443. The lightweight renderer 443 may be referred to as a lightweight renderer pipeline in terms of defining a rendering pipeline in which partial changes are allowed. The lightweight renderer 443 may include a renderer (e.g., a prebuilt renderer) built before execution of a software application. For example, the wearable device 101 may obtain a resource (e.g., API, system process, and/or library) used to define, create, and/or execute the entire rendering pipeline, based on the execution of the XR plug-in 444. The XR plug-in 444 may be referred to as an open XR native client in terms of defining (or setting) the entire rendering pipeline.

The wearable device 101 may display a screen representing at least a portion of a virtual space on the display 250, based on the execution of the XR application 442. The XR plug-in 441-1 included in the XR application 442 may include instructions supporting a function similar to the XR plug-in 444 of the XR system UI 441. Among descriptions of the XR plug-in 441-1, a description overlapping those of the XR plug-in 444 may be omitted. The wearable device 101 may cause execution of a virtual space manager 451, based on execution of the XR application 442.

For example, the wearable device 101 may display an image in a virtual space on the display 250, based on execution of an application 445. The application 445 may be configured to output image information for displaying a two-dimensional image. The wearable device 101 may cause execution of the virtual space manager 451, based on execution of the application 445. The wearable device 101 may create double image information to represent the two-dimensional image in a three-dimensional virtual space, based on the execution of the application 445. Herein, the double image information may include first image information for the left eye and second image information for the right eye, in consideration of binocular disparity. In order to represent the two-dimensional image in the three-dimensional virtual space, the wearable device 101 may create the double image information, based on image information for displaying the two-dimensional image.

According to an embodiment, the wearable device 101 may provide a virtual space service, based on the execution of the virtual space manager 451. For example, the virtual space manager 451 may include a platform for supporting a virtual space service. Based on the execution of the virtual space manager 451, the wearable device 101 may identify a virtual space formed based on a user's location indicated by data obtained through the sensor 420, and may display at least a portion of the virtual space on the display 250. The virtual space manager 451 may be referred to as a composition presentation manager (CPM).

The virtual space manager 451 may include a runtime service 452. As an example, the runtime service 452 may be referred to as an OpenXR runtime module (or OpenXR runtime program). The wearable device 101 may execute at least one of a user's pose prediction function, a frame timing function, and/or a space input function, based on the execution of the runtime service 452. As an example, the wearable device 101 may perform rendering for a virtual space service to a user, based on the execution of the runtime service 452. For example, based on the execution of runtime service 452, a function associated with a virtual space executable by the application layer 440 may be supported.

The virtual space manager 451 may include a pass-through manager 453. The wearable device 101 may display an image and/or a video representing an actual space obtained through an external camera superimposed on at least a portion of the screen, while displaying a screen representing a virtual space on display 250, based on the execution of the pass-through manager 453.

The virtual space manager 451 may include an input manager 454. The wearable device 101 may identify data (e.g., sensor data) obtained by executing one or more programs included in a perception service layer 470, based on the execution of the input manager 454. The wearable device 101 may identify a user input associated with the wearable device 101, by using the obtained data. The user input may be associated with the user's motion (e.g., hand gesture), gaze, and/or speech identified by the sensor 420 (e.g., the image sensor 421 such as an external camera). The user input may be identified based on an external electronic device connected (or paired) through a communication circuit.

For example, a perception abstract layer 460 may be used for data exchange between the virtual space manager 451 and the perception service layer 470. In terms of being used for data exchange between the virtual space manager 451 and the perception service layer 470, the perception abstract layer 460 may be referred to as an interface. As an example, the perception abstraction layer 460 may be referred to as OpenPX. The perception abstraction layer 460 may be used for a perception client and a perception service.

According to an embodiment, the perception service layer 470 may include one or more programs for processing data obtained from the sensor 420. One or more programs may include at least one of the location tracker 471, the space recognizer 472, the gesture tracker 473, the gaze tracker 474, and/or the face tracker 475, and/or the renderer 490. The type and/or number of one or more programs included in the perception service layer 470 is not limited as illustrated in FIG. 4.

The wearable device 101 may identify a posture of the wearable device 101 by using the sensor 420, based on the execution of the location tracker 471. The wearable device 101 may identify 6 degrees of freedom pose (6 dof pose) of the wearable device 101, based on the execution of the location tracker 471, by using data obtained using an external camera (e.g., the image sensor 421) and/or an IMU (e.g., motion sensor 422 including gyro sensor, acceleration sensor and/or geomagnetic sensor). The location tracker 471 may be referred to as a head tracking (HeT) module (or a head tracker or head tracking program).

The wearable device 101 may obtain information for providing a three-dimensional virtual space corresponding to a surrounding environment (e.g., external space) of the wearable device 101 (or a user of the wearable device 101), based on the execution of the space recognizer 472. The wearable device 101 may reproduce the surrounding environment of the wearable device 101 in three dimensions, by using data obtained using an external camera (e.g., the image sensor 421) based on the execution of the space recognizer 472. The wearable device 101 may identify at least one of a plane, an inclination, and a step, based on the surrounding environment of the wearable device 101 reproduced in three dimensions based on the execution of the space recognizer 472. The space recognizer 472 may be referred to as a scene understanding (SU) module (or a scene recognition program).

For example, the wearable device 101 may identify (or recognize) a hand's pose and/or gesture of the user of the wearable device 101 based on the execution of the gesture tracker 473. For example, the wearable device 101 may identify a pose and/or a gesture of the user's hand by using data obtained from an external camera (e.g., the image sensor 421), based on the execution of the gesture tracker 473. As an example, the wearable device 101 may identify a pose and/or a gesture of the user's hand, based on data (or image) obtained using an external camera based on the execution of the gesture tracker 473. The gesture tracker 473 may be referred to as a hand tracking (HaT) module (or a hand tracking program) and/or a gesture tracking module.

For example, the wearable device 101 may identify (or track) the movement of the user's eyes of the wearable device 101, based on the execution of the gaze tracker 474. For example, the wearable device 101 may identify the movement of the user's eyes, by using data obtained from a gaze tracking camera (e.g., the image sensor 421) based on the execution of the gaze tracker 474. The gaze tracker 474 may be referred to as an eye tracking (ET) module (or eye tracking program) and/or a gaze tracking module.

The perception service layer 470 of the wearable device 101 may further include the face tracker 475 for tracking the user's face. For example, the wearable device 101 may identify (or track) the movement of the user's face and/or the user's facial expression, based on the execution of the face tracker 475. The wearable device 101 may estimate the user's facial expression, based on the movement of the user's face based on the execution of the face tracker 475. For example, the wearable device 101 may identify the movement of the user's face and/or the user's facial expression, based on data (e.g., image and/or video) obtained using an FT camera (e.g., a camera facing at least a portion of the user's face, and the image sensor 421), based on the execution of the face tracker 475. The face tracker 475 may be referred to as a face tracking (FT) (or a face tracking program) and/or a face tracking module.

Referring to FIG. 4, as an example of the processor 410, a CPU 411, a graphics processing unit (GPU) 412, and/or a display processing unit (DPU) 413 are illustrated. The renderer 490 may include instructions for rendering images in a 3-dimensional virtual space. The processor 410 (e.g., the DPU 413) executing the renderer 490 may obtain at least one image to be displayed at least partially in a display area of the display 250 in a software application (e.g., a software application executed by the CPU 411 and/or the GPU 412). For example, the processor 410 executing the renderer 490 may determine a location of an area to which an application (e.g., XR application 442, application 445) is to be rendered. The processor 410 executing the renderer 490 may create an image of the application to be displayed on the display 250. The renderer 490 may synthesize the images to create a composite image to be displayed on the display 250.

The processor 410 executing the renderer 490 may divide a display area of the display 250 into a foveated portion (or may be referred to as a foveated area) and a peripheral portion (or may be referred to as a remaining area), by using a gaze location calculated using the location tracker 471 and/or the gaze tracker 474. For example, the processor 410 detecting coordinate values of the gaze location may determine a portion of the display area including the coordinate values as a foveated area. The DPU 413 executing the renderer 490 may obtain at least one image, corresponding to each of the foveated area and the remaining area, and having a size smaller than a size of the entire display area of the display 250 or a resolution less than a resolution of the display area.

The processor 410 executing the renderer 490 may obtain or create a composite image to be displayed on the display 250, by synthesizing an image corresponding to the foveated area and an image corresponding to a peripheral portion. For example, the processor 410 may enlarge the image corresponding to the peripheral portion to a size of the entire display area of the display 250, by performing upscaling. The processor 410 may create a composite image to be displayed on the display 250, by combine the image corresponding to the foveated area onto the enlarged image. The processor 410 may mix the enlarged image and the image corresponding to the foveated area, by applying a visual effect such as blur along a boundary line of the image corresponding to the foveated area.

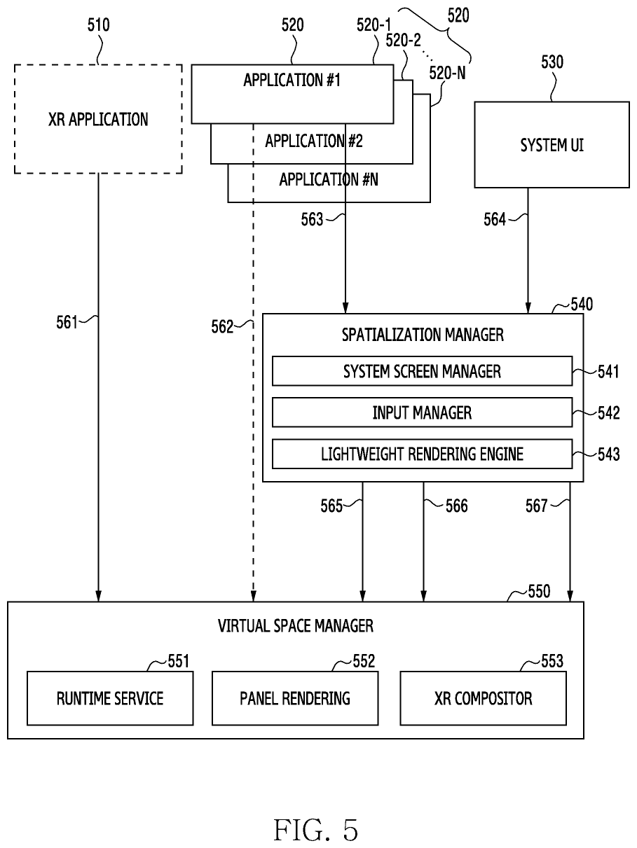

FIG. 5 illustrates an example of a block diagram of an electronic device (e.g., the electronic device 101 of FIG. 1, the wearable device 101 of FIGS. 2A to 4) for displaying an image in a virtual space according to an embodiment of the disclosure. In FIG. 5, an example in which a plurality of programs (or instructions) for displaying an image in a virtual space is executed is described. The plurality of programs (or instructions) may all be executed in one processor (e.g., AP) or may be executed by a plurality of processors (e.g., AP, graphics processing unit (GPU), neural processing unit (NPU)). The meaning of being executable by the plurality of processors may indicate that a portion of programs (or instructions) may be executed by a first processor and another portion of programs (or instructions) may be executed by a second processor different from the first processor.

Referring to FIG. 5, an electronic device 101 may execute a virtual space manager 550 (e.g., the virtual space manager 451 and the CPM of FIG. 4) to render an image in a virtual space. For the virtual space manager 550, descriptions of the virtual space manager 451 of FIG. 4 may be at least partially referenced. The virtual space manager 550 may include a platform for supporting a virtual space service. The virtual space manager 550 may include a runtime service 551 (e.g., OpenXR Runtime), a panel rendering 552 (e.g., two-dimensional (2D) Panel Render), and an XR compositor 553. The electronic device 101 may execute at least one of a user's pose prediction function, a frame timing function, and/or a space input function, based on the execution of the runtime service 551. For the runtime service 551, descriptions of the runtime service 452 of FIG. 4 may be at least partially referenced. The electronic device 101 may display at least one image (video) on a panel (e.g., a 2D panel) to implement a virtual space through the display 250, based on the execution of the panel rendering 552. For example, the electronic device 101 may display a rendering image corresponding to red, green, blue (RGB) information 566 for a panel from a spatialization manager 540 to be described later via a display (e.g., display 250). The electronic device 101 may synthesize an image of an actual area captured through a camera in a virtual space (hereinafter, a pass-through image) and a virtual area image, based on the execution of the XR compositor 553. For example, the electronic device 101 may create a composite image, by merging the pass-through image and the virtual area image, based on the execution of the XR compositor 553. The electronic device 101 may transmit the created composite image to a display buffer so that the composite image is displayed. The electronic device 101 may identify the virtual space through the virtual space manager 550, and display at least a portion of the virtual space on the display 250. The virtual space manager 550 may be referred to as the CPM. The electronic device 101 may execute the virtual space manager 550 to render an image corresponding to at least a portion of the virtual space.

According to an embodiment, the electronic device 101 may execute the spatialization manager 540. The spatialization manager 540 may perform processes for displaying an image in a three-dimensional virtual space. The electronic device 101 may perform preprocessing based on the execution of the spatialization manager 540 so that an image may be rendered in a three-dimensional virtual space through the virtual space manager 550. For example, the electronic device 101 may perform at least some of functions of the renderer 490 of FIG. 4, based on the execution of the spatialization manager 540. Based on the execution of the spatialization manager 540, the electronic device 101 may process image information provided by an application (e.g., an XR application 510, an application 520 providing a normal two-dimensional screen other than XR, and an application providing a system UI 530). The spatialization manager 540 (e.g., Space Flinger) may include a system screen manager 541 (e.g., System scene), an input manager L (e.g., Input Routing), and a lightweight rendering engine 543 (e.g., Impress Engine). The system screen manager 541 may be executed to display the system UI 530. System UI-related information 564 may be transmitted from a program (e.g., API) providing the system UI 530 to the system screen manager 541. The system UI-related information 564 may be obtained via a spatializer API and/or a Same-process private API. The spatialization manager 540 may determine a layout (e.g., location, display order) of a screen of the system UI 530 in a three-dimensional space, through pre-allocated resources. The system screen manager 541 may transmit image information 567 for rendering a screen of the system UI 530 to the virtual space manager 550, according to the layout. An input manager 542 may be configured to process a user input (e.g., user input on a system screen or an app screen). The input manager 542 may map a user input recognized by the sensor 420 of the electronic device 101 to at least one of one or more software applications (e.g., the XR application 510, the application 520 providing a normal two-dimensional screen other than XR, and an application providing the system UI 530) mapped to the virtual space by the spatialization manager 540. For example, mapping of a user input may include executing instructions (e.g., sub-routine and/or event handler) of a software application for processing the user input. The lightweight rendering engine 543 may be a renderer (e.g., the lightweight renderer 443) for image generation. For example, the lightweight rendering engine 543 may be used to display the system UI 530.

According to an embodiment, the spatialization manager 540 may include the lightweight rendering engine 543 for rendering the system UI. According to an embodiment, when the lightweight rendering engine 543 does not have enough resources to render an avatar used in the HMD, at least one external rendering engine may be used. In this case, an external rendering engine support module may be added inside the spatialization manager 540 to solve the compatibility issue with external rendering (e.g., 3rd party engine).

According to an embodiment, the electronic device may execute an application. For example, the virtual space manager 550 may be executed in response to the execution of the XR application 510 (e.g., the XR application 442, a three-dimensional (3D) game, an XR map, and other immersive applications). The electronic device 101 may provide the virtual space manager 550 with double image information 561 provided from the XR application 510. In order to display an image in a 3D space, the double image information 561 may include two image information considering binocular parallax. For example, in order to render in a 3-dimensional virtual space, the double image information 561 may include first image information for the user's left eye and second image information for the user's right eye. Hereinafter, in the disclosure, double image information is used as a term referring to image information for indicating images for two eyes in a 3-dimensional space. In addition to the double image information, binocular image information, double image data, double image, binocular image data, stereoscopic image information, 3D image information, spatial image information, spatial image data, 2D-3D conversion data, dimensional conversion image data, binocular parallax image data, and/or equivalent technical terms may be used. The electronic device 101 may generate a composite image by merging image layers through the virtual space manager 550. The electronic device 101 may transmit the generated composite image to a display buffer. The composite image may be displayed on the display 250 of the electronic device 101.

According to an embodiment, the electronic device may execute at least one of an application 520 (e.g., first application 520-1, second application 520-2, . . . , and Nth application 520-N) different from the XR application 510. According to an embodiment, the application 520 may be configured to output image information for displaying a two-dimensional (2D) image (e.g., window and/or activity). In other words, the application 520 may provide a two-dimensional image. As an example, the application 520 may be an image application, a schedule application, or an Internet browser application. When image information 562 provided from the application 520 is provided to the virtual space manager 550 in response to the execution of the application 520, since the image information 562 has only the x-coordinate and y-coordinate in the two-dimensional plane, it may be difficult to consider the order of precedence (i.e., a distance separated from the user) between other applications centered on the user. Even when displaying the application 520 providing a general 2D screen, the electronic device 101 may execute the spatialization manager 540 to provide double image information to the virtual space manager 550. For example, the electronic device 101 may receive application-related information 563 from the first application 520-1, based on the execution of the spatialization manager 540. For example, the application-related information 563 may include image information (e.g., information including RGB per pixel) indicating a two-dimensional image of the first application 520-1 and/or content information (e.g., characteristic of content executed in the first application, type of content) in the first application 520-1. The application-related information 563 may be obtained through a spatializer API. Based on the execution of the spatialization manager 540, the electronic device 101 may identify a location of an area in which the first application 520-1 is to be rendered and information (hereinafter, location information) on a size of the area to be rendered. Based on the execution of the spatialization manager 540, the electronic device 101 may create double image information 565 (e.g., RGBx2) in which the user's binocular disparity is considered, through the image information and the location information. Based on the execution of the spatialization manager 540, the electronic device 101 may provide the double image information 565 to the virtual space manager 550. By converting a simple two-dimensional image into the double image information 565, a problem occurring when the image information 562 is directly transmitted to the virtual space manager 550 may be solved. In addition, as at least some of functions for image display in a virtual space are performed by the spatialization manager 540 instead of the virtual space manager 550, the burden on the virtual space manager 550 may be reduced.

FIG. 6 illustrates an example of a structure of a plurality of layers according to an embodiment of the disclosure.

Referring to FIG. 6, programs installed in a wearable device 101 may be classified into one layer among a platform layer 610, a perception service layer 620 (e.g., the perception service layer 470 of FIG. 4), and a sensor service layer 630. For example, the wearable device 101 may operate based on the platform layer 610, the perception service layer 620, and the sensor service layer 630.

According to an embodiment, the platform layer 610 may be configured for an XR service. For example, the platform layer 610 may include a platform (e.g., an Android platform) for supporting the XR service. For example, the platform layer 610 may include the virtual space manager 550 of FIG. 5. The platform layer 610 may include a runtime service 611. For the runtime service 611, descriptions of the runtime service 551 of FIG. 5 and descriptions of the runtime service 452 of FIG. 4 may be referred to. As an example, the runtime service 611 may be referred to as an OpenXR runtime module. The runtime service 611 may be used to provide at least one of a pose prediction function of a user, a frame timing function, and/or a space input function via the wearable device 101. For example, the runtime service 611 may be used to perform rendering for the XR service to the user. For example, an application (e.g., unity or an OpenXR native application) may be implemented based on the runtime service 611.

A perception abstract layer 612 may be used for data exchange between the platform layer 610 and the perception service layer 620. For the perception abstract layer 612, descriptions of the perception abstract layer 460 of FIG. 4 may be referred to. For example, the perception abstract layer 612 may be referred to as OpenPX. The perception abstract layer 612 may be used for a perception client and a perception service.

According to an embodiment, the perception service layer 620 may include a service module 621, a perception plug-in layer 622, a sensor management module 623, a playback module 624, and/or an external data management module 625. For example, the perception service layer 620 may include at least one of the service module 621, the perception plug-in layer 622, the sensor management module 623, the playback module 624, and/or the external data management module 625. For example, the at least a portion of the service module 621, the perception plug-in layer 622, the sensor management module 623, the playback module 624, and the external data management module 625 may be omitted.

The service module 621 may manage input data of the wearable device 101. The service module 621 may be used to manage data (e.g., gesture information) obtained from a plurality of recognition modules included in the perception plug-in layer 622. As an example, the service module 621 may be referred to as SxrDataService. The service module 621 may manage data 640 received from an electronic device 601 managed by the external data management module 625.

The service module 621 may perform interfacing with an upper layer (e.g., the platform layer 610 or the runtime service 611). The service module 621 may exchange data with the upper layer (e.g., the platform layer 610 or the runtime service 611) via the perception abstract layer 612. As an example, the perception abstract layer 612 may be referred to as the OpenPX. According to an embodiment, the service module 621 may also support OpenXR extension as well as the OpenPX. The service module 621 may be used to exchange data (e.g., gesture information) between the plurality of recognition modules. The service module 621 may be configured to manage data processed by the perception service layer 620. The service module 621 may select data to be recognized as an input of the wearable device 101 among the data. The data may include data obtained from the plurality of recognition modules and data obtained via the external data management module 625. The service module 621 may manage data to be used in the perception abstract layer 612. The service module 621 may select the data to be recognized as the input of the wearable device 101 among the data to provide it to the perception abstract layer 612.

The perception plug-in layer 622 may include the plurality of recognition modules. The plurality of recognition modules may be referred to as a plurality of perception solutions.

As an example, the plurality of recognition modules may include at least one of a head tracking (HeT) module 622-1 (e.g., a location tracker 471), a scene understanding (SU) module or environment recognition module 622-2 (e.g., a space recognizer 472), a hand tracking (HaT) module 622-3 (e.g., a gesture tracker 473), an eye tracking (ET) module 622-4 (e.g., a gaze tracker 474), and a face tracking (FT) module 622-5 (e.g., a face tracker 475). Each of the plurality of recognition modules included in the perception plug-in layer 622 may include a common interface for a connection (or interworking) with the sensor management module 623. Each of the plurality of recognition modules may include a common interface for a connection (or interworking) with the sensor management module 623.

The head tracking module 622-1 may identify a posture of the wearable device 101 by using at least one sensor of the wearable device 101. As an example, the head tracking module 622-1 may identify a 6 degrees of freedom posture (6 dof pose) of the wearable device 101 based on data obtained by using a camera (e.g., the image sensor 421 of FIG. 4) and an IMU.

The environment recognition module 622-2 may be used to configure a surrounding environment of the wearable device 101 (or the user of the wearable device 101) as a three-dimensional virtual space. The environment recognition module 622-2 may be used to reconstruct the surrounding environment of the wearable device 101 in three dimensions based on data obtained by using the camera (e.g., the image sensor 421 of FIG. 4). The environment recognition module 622-2 may identify at least one of a plane, a slope, and a step based on the surrounding environment of the wearable device 101 reproduced in three dimensions.

The hand tracking module 622-3 may be used to identify (or recognize) a pose and/or a gesture of a hand of the user the wearable device 101. For example, the hand tracking module 622-3 may identify the pose and/or the gesture of the hand of the user based on data obtained from at least one sensor. As an example, the hand tracking module 622-3 may identify the pose and/or the gesture of the hand of the user based on data (e.g., an image) obtained by using a camera.

The eye tracking module 622-4 may be used to identify (or track) movement of eyes of the user of the wearable device 101. As an example, the eye tracking module 622-4 may identify the movement of the eyes of the user based on data obtained from the at least one sensor. As an example, the eye tracking module 622-4 may identify the movement of the eyes of the user based on data obtained by using a camera (e.g., the eye tracking camera 260-1 of FIGS. 2B and 3A) and/or an infrared light emitting diode (IR LED).

The face tracking module 622-5 may be used to identify (or track) movement of the face of the user and/or a facial expression of the user. The face tracking module 622-5 may estimate the facial expression of the user based on the movement of the face of the user. As an example, the face tracking module 622-5 may identify the movement of the face of the user and/or the facial expression of the user based on data (e.g., an image) obtained by using a camera (e.g., the camera 260 of FIGS. 2A and 2B).

As an example, the plurality of recognition modules (e.g., the head tracking module 622-1, the environmental recognition module 622-2, the hand tracking module 622-3, the eye tracking module 622-4, and the face tracking module 622-5) included in the perception plug-in layer 622 may be configured in a plug-in structure. As an example, some of the plurality of recognition modules may be replaced with another module regardless of the sensor service layer 630 and the platform layer 610, which are lower layers of the perception service layer 620.

According to an embodiment, the sensor management module 623 may be used to provide (or transmit) data via an interface common to each of the plurality of recognition modules. For example, the sensor management module 623 may be used to separate (or remove) dependency between the sensor service layer 630, which is a lower layer, and the perception plug-in layer 622, which is an upper layer. For example, the sensor management module 623 may be referred to as SxrSensorSeviceManger.

The sensor management module 623 may support various modules (or sensor services) of the sensor service layer 630. The plurality of recognition modules may not directly interface with the sensor service layer 630. The plurality of recognition modules may receive data (e.g., sensor data) via the sensor management module 623. Therefore, even when a module of the sensor service layer 630 is changed, the plurality of recognition modules may not be affected.

The sensor management module 623 may further include a load balancing module. The load balancing module may identify data provided from the sensor service layer 630. The load balancing module may identify a recognition module of at least a portion of the plurality of recognition modules based on the data provided from the sensor service layer 630. The load balancing module may provide data to the identified at least a portion of the recognition modules. As an example, the load balancing module may distribute data to the plurality of recognition modules based on a state of the plurality of recognition modules and/or a state of the wearable device 101. For example, the load balancing module may filter the data provided to the plurality of recognition modules based on the state of the plurality of recognition modules and/or the state of the wearable device 101. According to an embodiment, the load balancing module may be configured independently of the sensor management module 623. The load balancing module may be referred to as SxrPerceptionLoadBalancer.

The playback module 624 may be used to provide a stored dataset to at least one of the plurality of recognition modules in real time via playback. As an example, the dataset may be stored via the playback module 624 based on a designated standard. The dataset may include not only first data obtained from the sensor service layer 630 but also second data (e.g., virtual object data or synthetic data) obtained based on the first data obtained from the sensor service layer 630. As an example, the first data may be referred to as sensor data. The second data may be referred to as virtual data.

According to an embodiment, the wearable device 101 may receive data from an external electronic device (e.g., the electronic device 601). For example, the data received from the external electronic device may include first data obtained from a service layer included in the external electronic device and/or second data obtained based on the first data. The wearable device 101 may perform a playback (or a playback function) by using the data received from the external electronic device. The wearable device 101 may transmit a result in which the playback (or the playback function) is performed to the external electronic device. For example, the wearable device 101 may be used to process the data obtained from the external electronic device instead. The wearable device 101 may receive data obtained from the at least one sensor of the external electronic device. The wearable device 101 may obtain information (e.g., information on a 6 degrees of freedom posture) obtained via the playback module 624 (or the plurality of recognition modules) based on the received data. The wearable device 101 may transmit the obtained information to the external electronic device. The external electronic device may provide an XR service based on the obtained information.

The playback module 624 may perform the playback (or the playback function) based on at least one of the first data and the second data. According to an embodiment, the playback module 624 may perform the playback by combining (or mixing) real-time data (e.g., runtime data) and pre-stored data.

As an example, the playback may mean a function of using stored data (or gesture information) according to an operation of the wearable device 101. As an example, the playback may mean a function of identifying a value for a performance of the XR service via comparison between gesture information obtained based on a designated operation related to the XR service and reference gesture information according to the designated operation.

As an example, the playback may mean a function for obtaining performance information of the XR service provided to the user of the wearable device 101. The playback module 624 may identify information (e.g., gesture information) on the user who has performed a designated operation (e.g., a mission) related to the XR service. The playback module 624 may identify reference information on the designated operation. The reference information may mean information for determining whether a performance of the designated operation is completed. The playback module 624 may identify a degree of similarity between information on the user who has performed the designated operation, and the reference information. The playback module 624 may identify whether the performance of the designated operation has been completed by the user based on the similarity.

According to an embodiment, the playback module 624 may be included in the sensor management module 623. For example, the playback module 624 may perform the playback via the sensor management module 623 without changing the plurality of recognition modules.

The external data management module 625 may be used to manage data (e.g., the data 640) obtained via the external electronic device (e.g., the electronic device 601) (or at least one sensor of the external electronic device) connected to the wearable device 101. The external data management module 625 may indicate the data 640 obtained via the electronic device 601 as a module for use in the wearable device 101. The electronic device 601 may correspond to a smart watch, a smart phone, a smart TV, a smart monitor, or a tablet PC. However, it is not limited thereto. As an example, the electronic device 601 may include or correspond to at least a portion of the electronic device 101 of FIG. 1.

According to an embodiment, the external data management module 625 may improve accuracy of the plurality of recognition modules by using the data 640 obtained from the electronic device 601. As an example, the external data management module 625 may correct data (or gesture information) obtained from the plurality of recognition modules by using the data 640 obtained from the electronic device 601. According to an embodiment, the external data management module 625 may not be included in the perception service layer 620. According to an embodiment, the external data management module 625 may be included in the perception abstract layer 612.

The external data management module 625 may receive the data 640 included in a user input back channel (UIBC) message from the electronic device 601. The data 640 may be encapsulated in a message (or a data packet) according to a Wi-Fi™ display specification. The wearable device 101 may recognize the data 640 as an input with respect to the wearable device 101. The wearable device 101 may execute a function corresponding to the data 640. The data 640 may include data related to a touch input for a display of the electronic device 601. For example, the data 640 may include a coordinate value of a point at which an external object is in contact on the display of the electronic device 601. The external data management module 625 may provide the data 640 to the perception service layer 620. For example, the perception service layer 620 may use the data 640 within the wearable device 101 by providing the data 640 to the perception abstract layer 612. For example, the wearable device 101 may recognize the data 640 as an input of the wearable device 101.

According to an embodiment, the wearable device 101 may prioritize data of the external data management module 625 between the data (e.g., the data 640) of the external data management module 625 and data obtained by the perception plug-in layer 622. When the data 640 is recognized as an input of the wearable device 101, the perception abstract layer 612 may refrain from or bypass receiving the data obtained by the perception plug-in layer 622. The wearable device 101 may recognize the data 640 as an input of the wearable device 101, from among the data obtained by the perception plug-in layer 622, and the data 640, based on the external data management module 625 receiving the data 640. The service module 621 may select the data 640, from among the data obtained by the perception plug-in layer 622, and the data 640.

The sensor service layer 630 may be used to control at least one sensor (e.g., a camera, an IMU, a time of flight (TOF) sensor). For example, the sensor service layer 630 may be used to provide a service for access to the at least one sensor. For example, the sensor service layer 630 may include at least one of a module for a VR service (e.g., QVRservice), a module for the XR service (e.g., SxrSensorService), a sensor API (e.g., an android sensor API), and a sensor hardware abstraction layer (sensor HAL).

According to an embodiment, the sensor management module 623 may provide sensor data to the perception plug-in layer 622 via a common interface. For example, the sensor management module 623 may provide sensor data to each of the plurality of recognition modules (e.g., the head tracking module 622-1, the environment recognition module 622-2, the hand tracking module 622-3, the eye tracking module 622-4, and the face tracking module 622-5) via the identical interface. For example, the sensor management module 623 may provide sensor data according to an operation of a recognition module to the recognition module without changing setting information of the perception plug-in layer 622 based on changing (or modifying) setting information (e.g., a configuration file) on the sensor management module 623.

The sensor management module 623 may identify sensor data for the at least one recognition module based on an operation of at least one recognition module among the plurality of recognition modules. The sensor management module 623 may provide the identified sensor data to the at least one recognition module.

According to an embodiment, when the head tracking module 622-1 is driven, the sensor management module 623 may obtain camera data and IMU data in the sensor service layer 630, via at least one of the module for the VR service, the module for the XR service, the sensor API, and a sensor hardware abstraction layer. The sensor management module 623 may provide the camera data and the IMU data to the head tracking module 622-1. According to an embodiment, the camera data and the IMU data may be obtained via different modules.

According to an embodiment, when the environment recognition module 622-2 is driven in a playback mode, the sensor management module 623 may identify the stored camera data and the stored posture data. The sensor management module 623 may provide the camera data and the posture data to the environment recognition module 622-2.

According to an embodiment, the service module 621 may be configured to remove dependency on an upper layer of the perception plug-in layer 622. For example, the upper layer of the perception plug-in layer 622 may include a platform layer 610 (e.g., an android XR) and/or an application layer (e.g., the application layer 440 of FIG. 4).

The service module 621 may manage input data of the wearable device 101. The service module 621 may be configured to integrate and manage information (e.g., gesture information or tracking data) obtained from the plurality of recognition modules. The service module 621 may convert the information (e.g., the gesture information or the tracking data) according to a requirement of the upper layer without changing the plurality of recognition modules and then provide the converted information to the upper layer.

As an example, the service module 621 may obtain information on the 6 degrees of freedom posture from the head tracking module 622-1. The information on the 6 degrees of freedom posture obtained from the head tracking module 622-1 may be configured in a quaternion format. On the other hand, an upper layer (e.g., the platform layer 610) may request information on a 6 degrees of freedom posture configured in an axis-angle representation format. The service module 621 may change (or convert) the information on the 6 degrees of freedom posture configured in the quaternion format into the information on the 6 degrees of freedom posture configured in the axis-angle representation format. The service module 621 may provide the information on the 6 degrees of freedom posture configured in the axis-angle representation format to the upper layer (e.g., the platform layer 610). However, it is not limited thereto. For example, the service module 621 may change (or convert) the information on the 6 degrees of freedom posture configured in the axis-angle representation format into the information on the 6 degrees of freedom posture configured in the quaternion format and then provide it to the upper layer.

As an example, the service module 621 may obtain information on movement of the hand from the hand tracking module 622-3. The information on the movement of the hand may be obtained based on movement of a first number of joints. In contrast, the upper layer (e.g., the platform layer 610) may request information on movement of the hand obtained based on movement of a second number of joints. The service module 621 may perform one of a joint interpolation procedure or a simplification procedure. The service module 621 may support a structure of a joint required by the upper layer based on performing one of the joint interpolation procedure and the simplification procedure.

According to an embodiment, when worn by the user, the wearable device 101 may include an immersive device that blocks a gaze of the user. For example, the wearable device 101 may include a head mounted device (HMD). For example, for the user wearing the wearable device 101, a touch input with respect to a display (e.g., the display 250) may be restricted or difficult. The user wearing the wearable device 101 may control the wearable device 101 using a gesture input and/or a gaze input. A frequency of use of the gesture input in the wearable device 101 may be greater than a frequency of use of the touch input on the display 250. The number of functions executable by the touch input in the wearable device 101 may be less than the number of functions executable by the gesture input in the wearable device 101. A frequency of use of the gaze input in the wearable device 101 may be greater than the frequency of use of the touch input on the display 250. The number of functions executable by the touch input in the wearable device 101 may be less than the number of functions executable by the gaze input in the wearable device 101.

The wearable device 101 may use the data 640 received from the electronic device 601 by using the external data management module 625. The wearable device 101 may be controlled by the data 640 by using the external data management module 625. The data 640 may include coordinate data of a touch input obtained by the electronic device 601. The wearable device 101 may execute a function according to the coordinate data of the touch input obtained by the electronic device 601 by using the external data management module 625. When the data 640 includes the coordinate data of the touch input obtained by the electronic device 601, since the number of functions executable by the touch input of the wearable device 101 is relatively small, it may cause inconvenience to the user. In order to control relatively many functions of the wearable device 101, a method of using the data 640 including gesture input data and/or gaze input data may be required.

In the disclosure, technique in which the wearable device 101 is controlled by a multimodal input (e.g., a gesture input and/or a gaze input) obtained from the electronic device 601 may be described. The data 640 obtained via the electronic device 601 may be obtained by the electronic device 601 by using a camera (e.g., a camera module, or an image sensor) of the electronic device 601 and/or a sensor (e.g., a sensor module, or a motion sensor) of the electronic device 601. As a non-limiting example, the data 640 may be generated by performing preprocessing data obtained by using the camera of the electronic device 601 and/or the sensor of the electronic device 601. For example, the data 640 may include movement data (or movement information) of an external object (e.g., a part of a body, a hand, or a pupil). For example, the data 640 may include voice data obtained via a microphone of the electronic device 601.

According to an embodiment of the disclosure, the wearable device 101 may execute the method of using the data 640 including the multimodal input by using the external data management module 625. For example, the wearable device 101 may execute a function according to the data 640 including the multimodal input. For example, the wearable device 101 may display a visual object according to the data 640 on the display 250. This method will be described and exemplified in FIGS. 7 to 12.

FIG. 7 illustrates an example of a guide mode of a wearable device displaying a visual object corresponding to data (e.g., data included in a message 720) of an electronic device (e.g., the electronic device 601) according to an embodiment of the disclosure. The wearable device 101 of FIG. 7 may be an example of the electronic device 101 of FIG. 1 and the wearable device 101 of FIGS. 2A, 3A, and 3B.

Referring to FIG. 7, an electronic device 701 may be one of various types of mobile devices, such as a laptop, a smartphone (e.g., a bar-type smartphone, a foldable-type smartphone, or a rollable-type smartphone) with various form factors, a tablet, a cellular phone, and other similar computing devices. However, it is not limited thereto. The electronic device 701 may include a fixed electronic device such as a desktop computer or a TV. For example, the electronic device 701 may be referred to as a user device, a multifunctional device, or a portable device. For example, the electronic device 701 may be an example of the electronic device 101 of FIG. 1. The electronic device 701 may include communication circuitry (not illustrated), a camera 702 (e.g., including at least a portion of the camera module 180), a display 703 (e.g., including at least a portion of the display module 160), memory (e.g., the memory 130), and a processor (e.g., the processor 120).

Referring to FIG. 7, a wearable device 101 may display a screen 730 via a display 250. The screen 730 may represent at least a portion of a three-dimensional space. For example, the screen 730 may include an executable object (or a visual object) (e.g., an application). The screen 730 may provide a virtual space (or virtual reality) to a user of the wearable device 101.

The wearable device 101 may execute a designated function based on receiving an input for executing a function. For example, the input may include a gesture input and/or a gaze input. However, it is not limited thereto. For example, the wearable device 101 may receive a gesture input by executing a gesture tracker (e.g., the gesture tracker 473) based on data (e.g., hand tracking data) obtained via a camera (e.g., the image sensor 421). For example, the wearable device 101 may receive a gaze input by executing the gaze tracker 474 based on data (e.g., eye tracking data) obtained via the camera (e.g., the image sensor 421).

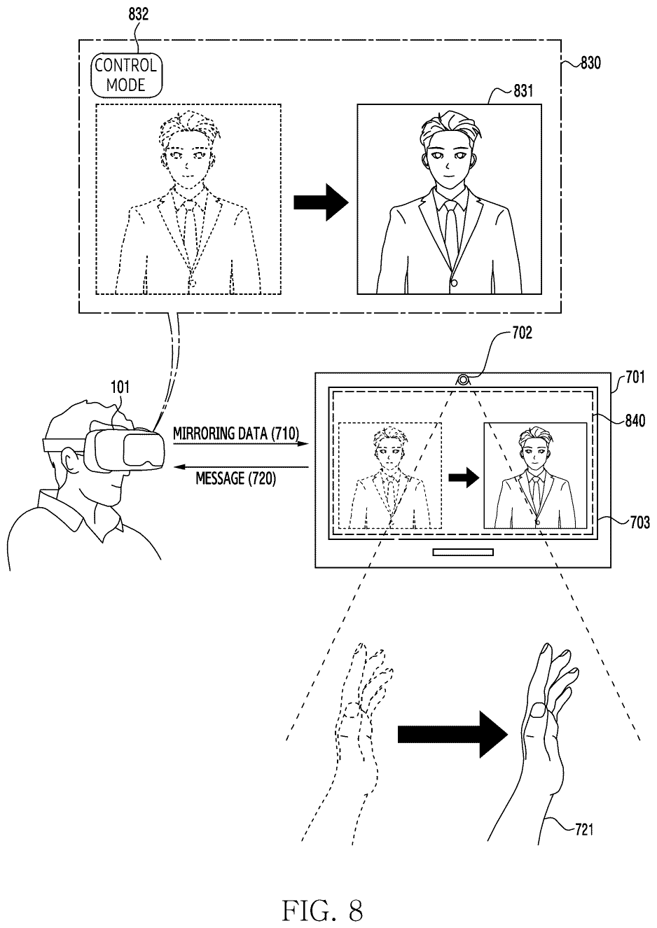

The wearable device 101 may transmit or provide mirroring data 710 to the electronic device 701 via communication circuitry 430. The mirroring data 710 may be described as data for mirroring (or streaming) a screen (e.g., the screen 730, the screen 830 in FIG. 8) displayed on the display 250 of the electronic device 101 to the electronic device 701. The mirroring data 710 may be described as data causing a screen 740 to be displayed on the display 703 of the electronic device 701. The electronic device 701 may display the screen 740 on the display 703 based on receiving the mirroring data 710.

The screen 730 may correspond to the screen 740. For example, the screen 740 may be the same as or similar to the screen 730. For example, a size of the screen 740 and a size of the screen 730 may be different. For example, the screen 740 may be the same as or similar to at least a portion of the screen 730. The screen 740 may include a portion of a plurality of window pop-ups within the screen 730. For example, the screen 740 may include a portion of a plurality of contents within the screen 730.

The electronic device 701 may transmit the message 720 including input data (e.g., the data 640) to the wearable device 101 via the communication circuitry. The wearable device 101 may receive the message 720 including the input data from the electronic device 701 via the communication circuitry 430. The wearable device 101 may recognize the input data in the message 720 as an input to the wearable device 101. The wearable device 101 may recognize the input data in the message 720 as the input to the wearable device 101 by using an external data management module (e.g., the external data management module 625). Controlled by input data in the message 720 received from the external electronic device 701 by the wearable device 101 may be referred to as a user input back channel (UIBC). The wearable device 101 may be referred to as a source device. The electronic device 701 may be referred to as a sink device.

According to an embodiment, the electronic device 701 may receive a touch input (or a tap input) on the display 703. Based on receiving the touch input via the display 703, the electronic device 701 may transmit the message 720 including coordinate data of a contact point to the wearable device 101. The wearable device 101 may recognize the coordinate data as an input to the wearable device 101 based on receiving the message 720 including the coordinate data via the communication circuitry 430. The wearable device 101 may execute the same function as a function of a touch input (or a tap input) for a point in the display 250 corresponding to the coordinate data.

According to an embodiment of the disclosure, the electronic device 701 may photograph an external object 721 (e.g., a part of a body) via the camera 702. The electronic device 701 may photograph the external object 721 moving through the camera 702 while displaying the screen 740 via the display 703. The electronic device 701 may obtain images representing movement of the external object 721. The electronic device 701 may transmit the message 720 including images representing the movement of the external object 721 to the wearable device 101 via the communication circuitry.

The wearable device 101 may obtain movement data of the external object 721 by using at least a portion of the images in the received message 720. For example, the external object 721 may be a hand of a user of the electronic device 701. The movement data may be referred to as hand tracking data. The wearable device 101 may identify a gesture input based on the movement data. For example, the external object 721 may be one or more eyes of the user. The movement data may be referred to as eye tracking data. The wearable device 101 may identify a gaze input based on the movement data. The gesture input and/or the gaze input may be referred to as a user input.

The wearable device 101 may display a visual object 731 corresponding to movement data of the external object 721 via the display 250. A mode in which the wearable device 101 displays the visual object 731 corresponding to the movement data of the external object 721 on the display 250 may be referred to as a guide mode. The visual object 731 may be included in the screen 730. The visual object 731 may include a visual guide. For example, the visual object 731 may be indicated as a visual object for assisting a user input of the user wearing the wearable device 101. The visual object 731 may guide a user input corresponding to movement data in the message 720 to the user of the wearable device 101. The wearable device 101 may execute a function corresponding to the movement data of the external object 721 based on receiving the user input corresponding to the visual object 731. For example, the function may be the same as a function intended to be executed by the user of the electronic device 701 via the movement of the external object 721.

According to an embodiment, when the movement data of the external object 721 corresponds to the hand of the user moving in a direction, the visual object 731 may indicate the direction. For example, the visual object 731 may include an indicator pointing a direction in which the external object 721 moves. The wearable device 101 may identify a part (e.g., the hand of the user) of a body moving in the direction via a camera (e.g., the image sensor 421) while the visual object 731 is displayed. The wearable device 101 may change the screen 730 displayed on the display 250 according to identifying the part of the body moving in the direction. For example, an executable object in the screen 730 may move in the direction. For example, a background in the screen 730 may move in the direction. However, it is not limited thereto.

In FIG. 7, the visual object 731 is illustrated as a visual object indicating a direction, but this is only an example. The visual object 731 may have a shape different from an illustration of FIG. 7. The shape of the visual object 731 may differ according to movement data of the external object 721 in the message 720. According to an embodiment, when the movement data of the external object 721 in the message 720 corresponds to the hand of the user that performs a pressing operation (or a tap operation) in a space, the wearable device 101 may display a visual object emphasizing an executable object (e.g., an application) in the screen 730. For example, the visual object emphasizing the executable object may include a pointer indicating the executable object.

According to an embodiment of the disclosure, while the wearable device 101 provides the guide mode, the wearable device 101 may display the screen 730 including the visual object 731 assisting the user of the wearable device 101 based on the images in the message 720. The display of the visual object 731 may be controlled by the external object 721. According to the assistance of the external object 721, the user of the wearable device 101 may execute a function of the wearable device 101 that has not recognized. The wearable device 101 may reinforce a user experience by executing the function of the wearable device 101 that the user has not recognized.

The wearable device 101 may obtain movement data of the external object 721 based on providing data (e.g., images) in the message 720 from an external data management module (e.g., the service module 621) to a service module (e.g., the external data management module 625). For example, the wearable device 101 may identify a user input (e.g., a gesture input or a gaze input) using the service module 621.

According to an embodiment, the wearable device 101 may identify the user input (e.g., the gesture input or the gaze input) from the images in the message 720 using the perception abstract layer 612. The wearable device 101 may obtain movement data of the external object 721 in the images by using the perception abstract layer 612.

According to an embodiment, the wearable device 101 may provide movement data of the external object 721 to a virtual space manager (e.g., the virtual space manager 451 of FIG. 4, the virtual space manager 550 of FIG. 5, and the CPM). The wearable device 101 may provide the movement data of the external object 721 to a lightweight rendering engine (e.g., the lightweight rendering engine 543 of FIG. 5) from the virtual space manager. The lightweight rendering engine 543 may be referred to as an impress engine. The wearable device 101 may display, via the display 250, the visual object 731 corresponding to the movement data of the external object 721 by using the lightweight rendering engine 543. The wearable device 101 may provide data of the visual object 731 generated via the lightweight rendering engine 543 to an application that provides a system UI (e.g., a system UI 530). The visual object 731 may be an example of the system UI 530. The wearable device 101 may display the visual object 731 via the display 250 according to execution of the application that provides the system UI 530. The visual object 731 may be referred to as a guide user interface. For example, the visual object 731 may include an arrow, a circle, a square, and a star shape. For example, the visual object 731 may be configured as a dotted line and/or a solid line.

According to an embodiment, while the wearable device 101 provides the guide mode, the wearable device 101 may display the screen 730 including a visual object 732. The visual object 732 may be described as a visual object for indicating that the guide mode is being provided to the user of the wearable device 101. For example, the visual object 732 may include text. For example, the visual object 732 may change color. For example, the visual object 732 may be displayed at a boundary of the screen 730. For example, the visual object 732 may be an object that changes color without including text.

According to an embodiment, the wearable device 101 may provide a visitor mode according to a setting of a user. The visitor mode may be described as a mode for a user not registered in the wearable device 101. The visitor mode may be indicated as a mode for a user who has no experience in controlling the wearable device 101. The visitor mode may be referred to as a guest mode. While providing the visitor mode, the wearable device 101 may mirror (or stream) the screen 730 to the electronic device 701 according to an input of the user. For example, the electronic device 701 may be owned by a visitor (e.g., a user who has no experience in controlling the wearable device 101, or a user who is not registered in the wearable device 101). The wearable device 101 may display the screen 730 including the visual object 731 assisting the visitor of the wearable device 101 based on images (e.g., included in the message 720) obtained via the electronic device of the visitor while providing the visitor mode.

FIG. 8 illustrates an example of a control mode of a wearable device that executes a function corresponding to data (e.g., a command included in the message 720) of an electronic device (e.g., the electronic device 701 of FIG. 7 or the electronic device 601 of FIG. 6) according to an embodiment of the disclosure. The wearable device 101 of FIG. 8 may be an example of the electronic device 101 of FIG. 1 and the wearable device 101 of FIGS. 2A to 3B.

Referring to FIG. 8, a wearable device 101 may display a screen 830 via a display 250. The screen 830 may include an image 831. The wearable device 101 may mirror (or stream) the screen 830 to an electronic device 701. The wearable device 101 may transmit mirroring data 710 to the electronic device 701 via communication circuitry (e.g., the communication circuitry 430) to perform mirroring. For the mirroring data 710, descriptions of the mirroring data 710 of FIG. 7 may be referred to.

The electronic device 701 may display a screen 840 via a display 703. The screen 840 may correspond to the screen 830. For example, the screen 840 may be the same as or similar to the screen 830. For example, the screen 840 may be the same as the reduced screen 830. For example, the screen 840 may include an image corresponding to the image 831. For the screen 830 and the screen 840, descriptions for the screen 730 and the screen 740 of FIG. 7 may be referred to.

The electronic device 701 may obtain movement data of an external object 721 via a camera 702. The electronic device 701 may identify a gesture input based on the movement data of the external object 721. The electronic device 701 may identify a function of the wearable device 101 corresponding to the identified gesture input. The electronic device 701 may transmit the message 720 including a control command (e.g., the data 640) for executing a function of the wearable device 101 according to the gesture input to the wearable device 101 via communication circuitry (not illustrated). The control command may cause the wearable device 101 that has received the control command to execute a function according to the control command. For example, the control command may include a gesture input.

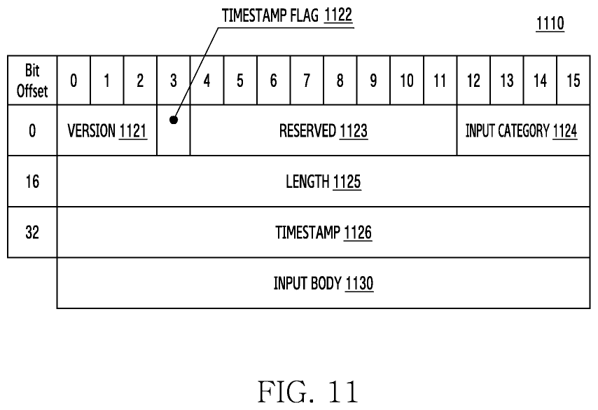

According to an embodiment, the message 720 may include the control command. The message 720 may indicate that the control command corresponds to a user input (e.g., a gesture input, or a gaze input) obtained via the camera 702 of the electronic device 701. For example, indicating that the control command in the message 720 is obtained via the camera 702 will be described and illustrated in more detail with reference to FIG. 11.

The wearable device 101 may receive the message 720 including the control command according to the external object 721 via the communication circuitry 430. The wearable device 101 may execute a function corresponding to the control command based on receiving the message 720 via the communication circuitry 430. A mode in which the wearable device 101 executes the function according to the control command in the message 720 may be referred to as a control mode. For example, when the movement data of the external object 721 indicates the external object 721 that moves in a direction, the control command may cause content (e.g., an image 831, a pop-up window, or a user interface) to move in the direction within the screen 830 of the wearable device 101. The wearable device 101 may move the image 831 in the direction within the screen 830 based on receiving the message 720 including the control command. However, the disclosure is not limited thereto.

According to an embodiment, while the wearable device 101 provides the control mode, the wearable device 101 may display the screen 830 including a visual object 832. The visual object 832 may indicate that the control mode is being provided to the user of the wearable device 101. The visual object 832 may display to the user of the wearable device 101 that the wearable device 101 is controlled according to the control command (e.g., the control command included in the message 720) received from the electronic device 701. For example, the visual object 832 may include text. As a non-limiting example, the visual object 832 may be indicated as an object (e.g., an icon) that changes color without including text.

According to an embodiment, the electronic device 701 may obtain images by photographing an environment including users via the camera 702. The electronic device 701 may identify a user occupying the largest area in the images. The electronic device 701 may identify a hand (e.g., the external object 721) of the user occupying the largest area based on the images obtained via the camera 702. The electronic device 701 may assign an identifier to the visual object corresponding to the external object 721 in the images. The identifier may be referred to as a hand identifier (ID). The electronic device 701 may obtain the identified movement data of the hand using the images. The electronic device 701 may transmit the message 720 including the movement data to the wearable device 101 via communication circuitry (not illustrated).

According to an embodiment, the electronic device 701 may obtain images including a plurality of hands via the camera 702. For example, the plurality of hands may be two. The electronic device 701 may assign a first identifier to a first hand based on the images. The electronic device 701 may assign a second identifier to a second hand based on the images. Identifiers (e.g., the first identifier and the second identifier) may be referred to as a hand ID. The electronic device 701 may obtain coordinate information of the first hand and motion information of the second hand by using the images. For example, the coordinate information of the first hand may include a coordinate indicating a path of a pointer corresponding to the first hand. For example, the coordinate information of the first hand may be referred to as movement information of the pointer corresponding to the first hand. For example, the coordinate information of the first hand may include movement information of a point pointed by a finger of the first hand. For example, the motion information of the second hand may include a gesture input according to movement data of the second hand.

The electronic device 701 may transmit, to the wearable device 101, the message 720 including the coordinate information of the first hand and the motion information of the second hand via the communication circuitry (not illustrated). The wearable device 101 may execute a function corresponding to the coordinate information of the first hand and the motion information of the second hand in the received message 720. For example, the wearable device 101 may move a pointer (not illustrated) within the screen 830 according to the coordinate information of the first hand. For example, the wearable device 101 may identify a gesture corresponding to the motion information of the second hand. For example, the wearable device 101 may execute a function corresponding to the gesture. For example, the wearable device 101 may cause the pointer to be positioned on content (e.g., a visual object, or an image 831) according to the coordinate information of the first hand. The wearable device 101 may cause the content to be selected or moved by using a gesture according to the motion information of the second hand while the pointer is positioned on the content.

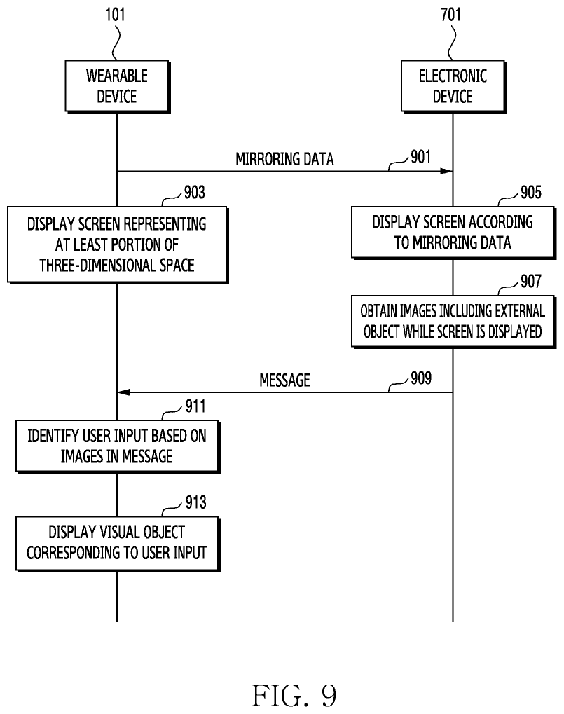

FIG. 9 illustrates an example of operations performed between a wearable device and an electronic device to display a visual object (e.g., the visual object 731 of FIG. 7) corresponding to data (e.g., images included in the message 720 of FIG. 7) obtained from the electronic device (e.g., the electronic device 601 of FIG. 6) on a display (e.g., the display 250 of FIG. 2A) of the wearable device according to an embodiment of the disclosure.

Referring to FIG. 9, in operation 901, a wearable device 101 (e.g., the processor 410) may transmit or provide mirroring data (e.g., the mirroring data 710) to an electronic device 701 via communication circuitry (e.g., the communication circuitry 430) while displaying a screen (e.g., the screen 730) via a display assembly (e.g., an assembly including the display 250). The screen 730 may represent at least a portion of a three-dimensional space. The mirroring data 710 may cause a screen corresponding to the screen of the wearable device 101 to be displayed via a display (e.g., the display 703) of the electronic device 701. The electronic device 701 may receive the mirroring data 710 from the wearable device 101.

In operation 903, the wearable device 101 (e.g., the processor 410) may display a screen (e.g., the screen 730) representing the at least a portion of the three-dimensional space via the display assembly. The display assembly may include a display (e.g., the display 250). In FIG. 9, operation 903 is illustrated as if it is executed after operation 901, but this is merely an example. For example, operation 903 may be performed before operation 901. For example, while the wearable device 101 is executing operation 903, operation 901, operation 909, operation 911, and operation 913 may be executed.

In operation 905, the electronic device 701 may display a screen (e.g., the screen 740) according to the mirroring data 710 via the display (e.g., the display 703). As the electronic device 701 displays the screen 740 according to the mirroring data 710 via the display 703, the user of the wearable device 101 may share a user experience with a user of the electronic device 701.

In operation 907, the electronic device 701 may obtain images including an external object (e.g., the external object 721) via a camera (e.g., the camera 702) while the screen 740 is displayed. For example, the images may indicate movement of the external object 721. For example, the images may include a gesture input represented by the external object 721. For example, the images may include a gaze input represented by the external object 721.

In operation 909, the electronic device 701 may transmit a message (e.g., the message 720) including the images to the wearable device 101 via the communication circuitry (not illustrated) of the electronic device 701. The wearable device 101 may receive the message 720 from the electronic device 701 via the communication circuitry 430. The wearable device 101 may receive the message 720 from the electronic device 701 via the communication circuitry 430 while displaying the screen 730 via the display assembly. The wearable device 101 may receive the message 720 (or the images in the received message 720) from the electronic device 701 via the communication circuitry 430 while providing the mirroring data 710 to the electronic device 701. The wearable device 101 may provide the received message 720 (or the images in the received message 720) to an external data management module (e.g., the external data management module 625 of FIG. 6) of the wearable device 101. For example, the images in the message 720 may represent the movement of the external object 721.

According to an embodiment, the wearable device 101 may receive the message 720 from the electronic device 701 via a communication channel. The communication channel may be referred to as a user input back channel (UIBC). The message 720 may be transmitted via a transmission control protocol/internet protocol (TCP/IP).

In operation 911, the wearable device 101 (e.g., the processor 410) may identify a user input based on the images in the message 720. The wearable device 101 may provide images from the external data management module 625 to a perception service layer (e.g., the perception service layer 470 or the perception service layer 620). The wearable device 101 may identify the user input by processing images in a service module (e.g., the service module 621) in the perception service layer. The wearable device 101 may provide the identified user input from the perception service layer 620 to a virtual space manager (e.g., the virtual space manager 550 of FIG. 5) via a perception abstract layer (e.g., the perception abstract layer 460 or the perception abstract layer 612).

According to an embodiment, the wearable device 101 may process the images in the message 720 by using the perception abstract layer 612. For example, the wearable device 101 may obtain movement data of the external object 721 in the images by using the perception abstract layer 612. For example, the external object 721 may be a hand of a user of the electronic device 701. The wearable device 101 may identify a gesture input from the images by using the perception abstract layer 612. As a non-limiting example, the external object may be one or more eyes of the user. The wearable device 101 may identify a gaze input from the images by using the perception abstract layer 612. The wearable device 101 may provide the user input (e.g., the gesture input or the gaze input) identified by using the perception abstract layer 612 to the virtual space manager 550.

In operation 913, the wearable device 101 (e.g., the processor 410) may display a visual object (e.g., the visual object 731) corresponding to a user input via the display assembly. The wearable device 101 may provide the user input to a lightweight rendering engine (e.g., the lightweight rendering engine 543) via the virtual space manager 550. The wearable device 101 may render the visual object 731 corresponding to the user input by using the lightweight rendering engine 543. The visual object 731 may assist control of the user whose a field of view is blocked. By displaying the visual object 731, the wearable device 101 may guide the user who has no experience in controlling the wearable device 101. The user of the wearable device 101 may learn a control method faster when there is the visual object 731, than when there is not the visual object 731. The wearable device 101 is controlled by the user of the electronic device 701 while mirroring the screen, so that the user of the wearable device 101 may share a user experience with the user of the electronic device 701.

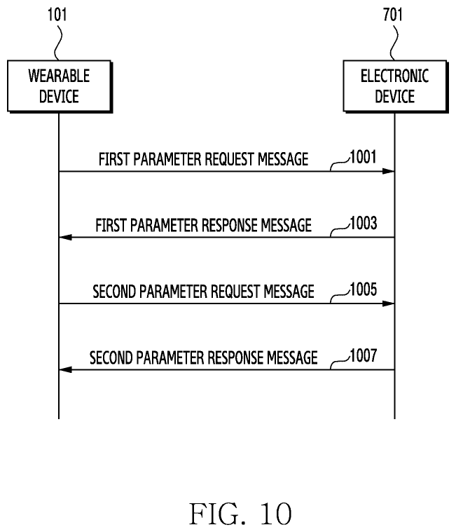

FIG. 10 illustrates an example of a capability negotiation performed between a wearable device and an electronic device according to an embodiment of the disclosure.

The capability negotiation of FIG. 10 may be performed between the wearable device 101 and the electronic device 701 before operation 901 of FIG. 9. For example, the capability negotiation illustrated in FIG. 10 may be referred to as user input back channel (UIBC) capability negotiation. The capability negotiation may be referred to as a setup process (or a setting process) for the electronic device 701 to transmit data (e.g., the data included in the message 720) obtained from the electronic device 701 to the wearable device 101. The capability negotiation may be performed to determine a set of parameters to be used in a subsequent communication process between the wearable device 101 and the electronic device 701. While performing the capability negotiation, the wearable device 101 may determine whether to recognize an input (e.g., a gesture input, or a gaze input) of the user received from the electronic device 701 as an input to the wearable device 101. The capability negotiation may be performed to exchange information used to transmit and receive content between the wearable device 101 and the electronic device 701. The information used to transmit and receive content may be used to ensure compatibility between the wearable device 101 and the electronic device 701. The information used to transmit and receive content may be used to perform an optimal operation between the wearable device 101 and the electronic device 701. For example, the information used to transmit and receive content may include a video compression method and/or an audio compression method. For example, the video compression method may include a video codec such as H.264 and/or a high efficiency video coding (HEVC). For example, the audio compression method may include an audio codec such as an advanced audio coding (AAC). The wearable device 101 and the electronic device 701 may use data obtained from the electronic device 701 in the wearable device 101 after performing operations illustrated in FIG. 10.

Referring to FIG. 10, in operation 1001, a wearable device 101 (e.g., the processor 410) may transmit a first parameter request message to an electronic device 701 via communication circuitry (e.g., the communication circuitry 430). The first parameter request message may be referred to as an M3 request in a Wi-Fi™ display specification. The wearable device 101 may transmit the first parameter request message to the electronic device 701 to obtain (or determine) a parameter list indicating the capability of the electronic device 701. The first parameter request message may include a request to transmit data of a list of parameters supported by the electronic device 701.

In operation 1003, the electronic device 701 may transmit the first parameter response message to the wearable device 101 (e.g., the processor 410) via the communication circuitry. The first parameter response message may be referred to as an M3 response in the Wi-Fi™ display specification. In response to the first parameter request message, the electronic device 701 may transmit the first parameter response message to the wearable device 101. The first parameter response message may include a response to parameters designated in the first parameter request message. For example, the first parameter response message may include a response to parameters such as ‘input category list=human interface device class (HIDC), ‘generic cap list=none’, ‘HIDC cap list=mouse/BT (Bluetooth™), ‘RemoteControl/infared’, and ‘port=none’. For example, the first parameter response message may include a response to parameters such as ‘input category list=generic’, ‘generic cap list=mouse’, ‘singletouch’, ‘HIDC cap list=none’, and ‘port=none’.

In operation 1005, the wearable device 101 (e.g., the processor 410) may transmit a second parameter request message to the electronic device 701 via the communication circuitry (e.g., the communication circuitry 430). The second parameter request message may be referred to as an M4 request and/or an M14 request in the Wi-Fi™ display specification. The wearable device 101 may transmit the second parameter request message to the electronic device 701 to determine (or set) values of parameters of the electronic device 701. The second parameter request message may include values of parameters to be used in a subsequent process. Types of the parameters may be based on the first parameter response message. For example, the second parameter request message may include a response to parameters such as ‘input category list=HIDC’, ‘generic cap list=none’, ‘HIDC cap list=mouse/BT (Bluetooth™), ‘RemoteControl/infared’, and ‘port=1000’. For example, the second parameter request message may include a response to parameters such as ‘input category list=generic’, ‘generic cap list=mouse’, ‘singletouch’, ‘HIDC cap list=none’, and ‘port=1000’.

In operation 1007, the electronic device 701 may transmit the second parameter response message to the wearable device 101 (e.g., the processor 410) via the communication circuitry. The second parameter response message may be referred to as an M4 response or an M14 response in the Wi-Fi™ display specification. The second parameter response message may indicate whether it is successful to set the values of the parameters of the electronic device 701 according to the second parameter request message.

FIG. 11 illustrates an example of a message (e.g., the message 720) transmitted from an electronic device (e.g., the electronic device 701) according to an embodiment of the disclosure.

Message 1110 illustrated in FIG. 11 may include the message illustrated in FIGS. 7, 8, 9, and 12.

Referring to FIG. 11, a message 1110 may include a version 1121, a timestamp flag 1122, a reserved 1123, an input category 1124, a length 1125, a timestamp 1126, and an input body 1130. The message 1110 may be referred to as a data packet.

The version 1121 may indicate a version of a specific communication protocol being implemented in the electronic device (e.g., the electronic device 701). The version 1121 may be indicated by a 3-bit field. The electronic device 701 may be referred to as a sink device.

The timestamp flag 1122 may indicate whether the timestamp 1126 exists. In the message 1110, the timestamp 1126 may be optional. When the timestamp 1126 exists, the timestamp flag 1122 may include “1”. When the timestamp 1126 does not exist, the timestamp flag 1122 may include “0”. The timestamp flag 1122 may be indicated by a 1-bit field.

When extracting data (e.g., payload data) from the message 1110, the reserved 1123 may be indicated by an 8-bit field that does not include information to be used. The reserved 1123 may be used to extract data from the message 1110 according to the data of the version 1121. The reserved 1123 may include additional data without changing a format in the message 1110.

The input category 1124 may be described as a 4-bit field for identifying an input category according to input data included by the input body 1130. The input category 1124 may indicate a format type of the input body 1130. The wearable device (e.g., the wearable device 101) may extract data from the input body 1130 by using data indicated by the input category 1124. The wearable device 101 may be referred to as a source device.

The length 1125 may be indicated by a 16-bit field indicating a length of the message 1110. The wearable device 101 may identify the end of the message 1110 by using data indicated by the length 1125.

The timestamp 1126 may be indicated by a 16-bit field for identifying a frame of a screen displayed on the electronic device 701 when user input data of the input body 1130 in the message 1110 is obtained.

The input body 1130 may include data indicating a user input (e.g., a gesture input, or a gaze input) obtained from the electronic device 701. The input body 1130 may be referred to as payload data. The input body 1130 may include images obtained via a camera (e.g., the camera 702) of the electronic device 701. The input body 1130 may include a control command generated based on the images.

The input body 1130 may be referred to as a human interface device class (HIDC) input body. A format of the HIDC input body may be referred to in Table 1, Table 2, and Table 3 below.

TABLE 1

| Field | Size (octet) | Value |
|---|---|---|
| HID Input Path | 1 | Described with reference to Table 2. |
| HID Type | 1 | Described with reference to Table 3. |
| Usage | 1 | Indicates the use of HIDC value. |
| Length | 2 | Indicates the length of the HIDC value. |
| HIDC value | changeable | Includes either an HID input report or |
| | | a HID report descriptor. |

TABLE 2

| Value | HID Input path |
|---|---|
| 0 | Infrared |
| 1 | USB |
| 2 | Bluetooth ™ |
| 3 | Zigbee ™ |
| 4 | Wi-Fi ™ |
| 5-254 | reserved |
| 255 | Vendor Specific HID interface |

TABLE 3

| Value | HID Type |
|---|---|
| 0 | Keyboard |
| 1 | Mouse |
| 2 | Single Touch |
| 3 | Multi Touch |
| 4 | Joystick |
| 5 | Camera |
| 6 | Gesture |
| 7 | Remote controller |
| 8-254 | reserved |
| 255 | Vendor Specific HID interface |

Table 1 may indicate a format of the HIDC input body. Table 2 may indicate a path of the user input obtained by the electronic device 701. Table 3 may indicate a type of the user input obtained by the electronic device 701. According to an embodiment, when the input body 1130 in the message 1110 includes images obtained by using the camera (e.g., the camera 702), a value of the HID Type may indicate a ‘camera’ or ‘reserved’. For example, when the input body 1130 in the message 1110 includes the images, a value indicated by the HID Type may be ‘5’. For example, when the input body 1130 in the message 1110 includes the images, a value indicated by the HID Type may be a designated value. The designated value may indicate the images.

According to an embodiment, when the input body 1130 in the message 1110 includes the control command, the value of the HID Type may indicate ‘reserved’. For example, when the input body 1130 in the message 1110 includes the control command, the value indicated by the HID Type may be a designated value. The designated value may indicate the control command.

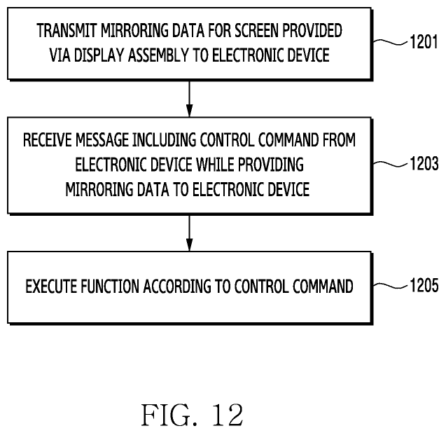

FIG. 12 illustrates an example of operations of a wearable device (e.g., the wearable device 101 of FIG. 2A) that executes a function according to a control command (e.g., the control command included in the message 720) of an electronic device (e.g., the electronic device 701 of FIG. 7 or the electronic device 601 of FIG. 6) according to an embodiment of the disclosure.

Referring to FIG. 12, in operation 1201, a wearable device 101 (e.g., the processor 410) may transmit mirroring data (e.g., the mirroring data 710) for a screen provided via a display assembly to an electronic device 701 via communication circuitry (e.g., the communication circuitry 430). Operation 1201 may correspond to operation 901 of FIG. 9.

In operation 1203, the wearable device 101 may receive a message (e.g., the message 720) including a control command from the electronic device 701 via the communication circuitry 430 while providing the mirroring data 710 to the electronic device 701. The control command may be generated in the electronic device 701. The control command may be generated based on images including an external object (e.g., the external object 721) obtained via a camera (e.g., the camera 702) of the electronic device 701. The electronic device 701 may identify a user input (e.g., a gesture input, or a gaze input) by using at least a portion of the images. The electronic device 701 may generate a control command according to the user input.

According to an embodiment, the control command may be generated in the electronic device 701 by using images including the external object 721 obtained via the camera 702. The control command may be described as data according to the user input identified from the images. Since the control command is data of the images processed in the electronic device 701, the wearable device 101 may use the control command via relatively few calculations.

According to an embodiment, the control command may include movement information of a pointer. The pointer may be described as an identifier corresponding to the external object 721. The pointer may be referred to as a cursor, an identifier, and/or an indicator. The pointer may be represented as a dot on a screen provided via a display (e.g., the display 250) of the wearable device 101. However, it is not limited thereto. The pointer may be represented as a visual object corresponding to a hand. The pointer may not be displayed on the screen. The movement information of the pointer may correspond to movement data of the external object 721 in the images. The movement information of the pointer may be referred to as a coordinate displacement value. The wearable device 101 may cause the pointer to move according to the movement information of the pointer on the screen.

The message 720 may indicate that the control command corresponds to the user input obtained via the camera 702 of the electronic device 701. The electronic device 701 may set the HID Type in the message 720 as the designated value. By using the value of the HID type in the message 720, the wearable device 101 may identify that the control command corresponds to the user input obtained via the camera 702.

In operation 1205, the wearable device 101 may execute a function according to the control command. Based on providing the control command from an external data management module (e.g., the external data management module 625) to a service module (e.g., the service module 621), the wearable device 101 may execute the function according to the control command.

According to an embodiment, when the control command includes the movement information of the pointer, the wearable device 101 may execute a function according to the movement information of the pointer on the screen while displaying the screen via the display 250. For example, the wearable device 101 may cause the screen to be changed in a direction according to the movement information of the pointer. For example, the wearable device 101 may move the visual object in the screen in the direction according to the movement information of the pointer. For example, the wearable device 101 may identify a gesture input corresponding to the movement information of the pointer. For example, the wearable device 101 may execute a function mapped in the gesture input.

In an embodiment according to the disclosure, a wearable device (e.g., the electronic device 101) may receive a message (e.g., the message 720) from an electronic device 701 while mirroring (or streaming) a screen (e.g., the screen 730) to the electronic device 701 (e.g., the electronic device 601, or the electronic device 701). The wearable device 101 may identify a user input (e.g., a gesture input) based on images in the message. The images may be obtained via a camera (e.g., the camera 702) of the electronic device 701. The wearable device 101 may display a visual object (e.g., the visual object 731) based on the user input. The visual object 731 may guide a user who has no experience (or is insufficient) in controlling the wearable device 101 with a control method. The user of the wearable device 101 may easily learn the control method by operating the wearable device according to the visual object 731. The user of the electronic device 701 may control the wearable device 101 based on the images obtained via the camera 702 of the electronic device 701. The user of the electronic device 701 may share a user experience of the wearable device 101.

The effects that may be obtained from the disclosure are not limited to the effects mentioned above, and other effects not mentioned will be clearly understood by those of ordinary skill in the art to which the disclosure pertains from the description below.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The technical problems to be achieved in this document are not limited to those described above, and other technical problems not mentioned herein will be clearly understood by those having ordinary knowledge in the art to which the disclosure belongs, from the following description.

As described above, a wearable device (e.g., the electronic device 101 of FIG. 1, the wearable device 101 of FIGS. 2A, 2B, 3A, 3B, and 4, the electronic device 101 of FIG. 5, or the wearable device 101 of FIGS. 7 to 10) may comprise a display assembly comprising at least one display (e.g., the display 250). The wearable device may comprise communication circuitry (e.g., the communication circuitry 430). The wearable device may comprise memory (e.g., the memory 415), comprising one or more storage media, storing instructions. The wearable device may comprise at least one processor (e.g., the processor 410) comprising processing circuitry. The instructions, when executed by the at least one processor individually or collectively, may cause the wearable device to transmit mirroring data (e.g., the mirroring data 710) for a screen (e.g., the screen 730) representing at least a portion of a three-dimensional space provided via the display assembly to an electronic device (e.g., the electronic device 701) via the communication circuitry. The instructions, when executed by the at least one processor individually or collectively, may cause the wearable device to, while providing the mirroring data to the electronic device to display a screen (e.g., the screen 740) according to the mirroring data on the electronic device, receive, a message (e.g., the message 720, or the message 1110) including images obtained via a camera (e.g., the camera 702) of the electronic device. The instructions, when executed by the at least one processor individually or collectively, may cause the wearable device to, based on the images in the message, identify a user input according to movement of an external object (e.g., the external object 721) in the images. The instructions, when executed by the at least one processor individually or collectively, may cause the wearable device to display, via the display assembly, a visual object (e.g., the visual object 731) corresponding to the user input.

According to an embodiment, the images may indicate a gaze of one or more eyes of a user.

According to an embodiment, the images may indicate a gesture for a portion of a user body.

According to an embodiment, the visual object may include an indicator pointing to a direction of the movement of the external object identified in accordance with the images.

According to an embodiment, the instructions, when executed by the at least one processor individually or collectively, may cause the wearable device to, based on providing the images in the message from an external data management module (e.g., the external data management module 625) of the wearable device to a service module (e.g., the service module 621) which manages input data of the wearable device, identify the user input.

According to an embodiment, the instructions, when executed by the at least one processor individually or collectively, may cause the wearable device to display, via the display assembly, the visual object, by providing the user input to a lightweight rendering engine of the wearable device via a virtual space manager of the wearable device.

According to an embodiment, the message may include user input back channel (UIBC) data. A value indicated by a human interface device (HID) type of UIBC data may indicate the images including the external object.

According to an embodiment, the instructions, when executed by the at least one processor individually or collectively, may cause the wearable device to, before transmitting the mirroring data to the electronic device, transmit a first message for user input back channel (UIBC) capability negotiation to the electronic device via the communication circuitry. The instructions, when executed by the at least one processor individually or collectively, may cause the wearable device to, before transmitting the mirroring data to the electronic device, based on receiving a second message indicating a response to the first message from the electronic device via the communication circuitry, establish a connection between the wearable device and the electronic device.

According to an embodiment, the instructions, when executed by the at least one processor individually or collectively, may cause the wearable device to display the visual object corresponding to the user input via the display assembly. The instructions, when executed by the at least one processor individually or collectively, may cause the wearable device to, based on receiving another input corresponding to the visual object, execute a function corresponding to the movement of the external object in the images.

According to an embodiment, the instructions, when executed by the at least one processor individually or collectively, may cause the wearable device to display the visual object corresponding to the user input via the display assembly. The instructions, when executed by the at least one processor individually or collectively, may cause the wearable device to display, via the display assembly, another visual object indicating a guide mode for displaying the visual object based on the images.

As described above, a method performed in a wearable device (e.g., the electronic device 101 of FIG. 1, the wearable device 101 of FIGS. 2A, 2B, 3A, 3B, and 4, the electronic device 101 of FIG. 5, or the wearable device 101 of FIGS. 7 to 10) comprising a display assembly comprising at least one display (e.g., the display 250) and communication circuitry (e.g., the communication circuitry 430) may comprise transmitting mirroring data for a screen representing at least a portion of a three-dimensional space provided via the display assembly to an electronic device via the communication circuitry. The method may comprise, while providing the mirroring data to the electronic device to display a screen (e.g., the screen 740) according to the mirroring data on the electronic device, receiving, a message (e.g., the message 720, the message 1110) including images obtained via a camera (e.g., the camera 702) of the electronic device, from the electronic device via the communication circuitry. The method may comprise, based on the images in the message, identifying a user input according to movement of an external object (e.g., the external object 721) in the images. The method may comprise displaying, via the display assembly, a visual object (e.g., the visual object 731) corresponding to the user input.

According to an embodiment, the images may indicate a gaze of one or more eyes of a user.

According to an embodiment, the images may indicate a gesture for a portion of a user body.

According to an embodiment, the visual object may include an indicator pointing to a direction of the movement of the external object identified in accordance with the images.

According to an embodiment, the method may comprise, based on providing the images in the message from an external data management module (e.g., the external data management module 625) of the wearable device to a service module (e.g., the service module 621) which manages input data of the wearable device, identifying the user input.

According to an embodiment, the method may comprise displaying, via the display assembly, the visual object, by providing the user input to a lightweight rendering engine of the wearable device via a virtual space manager of the wearable device.

According to an embodiment, the message may include user input back channel (UIBC) data. A value indicated by a human interface device (HID) type of the UIBC data may indicate the images including the external object.

According to an embodiment, the method may comprise, before transmitting the mirroring data to the electronic device, transmitting a first message for user input back channel (UIBC) capability negotiation to the electronic device via the communication circuitry. The method may comprise, before transmitting the mirroring data to the electronic device, based on receiving a second message indicating a response to the first message from the electronic device via the communication circuitry, establishing a connection between the wearable device and the electronic device.

According to an embodiment, the method may comprise displaying the visual object corresponding to the user input via the display assembly. The method may comprise, based on receiving another input corresponding to the visual object while displaying the visual object, executing a function corresponding to the movement of the external object in the images.

According to an embodiment, the method may comprise displaying the visual object corresponding to the user input via the display assembly. The method may comprise displaying, via the display assembly, another visual object indicating a guide mode for displaying the visual object based on the images.

As described above, a computer-readable storage media in which one or more programs are stored, the one or more programs may comprise instructions, when executed by a wearable device (e.g., the electronic device 101 of FIG. 1, the wearable device 101 of FIGS. 2A, 2B, 3A,3B, and 4, the electronic device 101 of FIG. 5, or the wearable device 101 of FIGS. 7 to 10) comprising a display assembly comprising at least one display (the display 250), and communication circuitry (e.g., the communication circuitry 430), causing the wearable device to transmit mirroring data (e.g., the mirroring data 710) for a screen representing at least a portion of a three-dimensional space provided via the display assembly to an electronic device (e.g., the electronic device 701) via the communication circuitry. The one or more programs may comprise instructions, when executed by the wearable device, causing the wearable device to, while providing the mirroring data to the electronic device to display a screen (e.g., the screen 740) according to the mirroring data on the electronic device, receive, a message (e.g., the message 720, or the message 1110) including images obtained via a camera (e.g., the camera 702) of the electronic device, from the electronic device via the communication circuitry. The one or more programs may comprise instructions, when executed by the wearable device, causing the wearable device to, based on the images in the message, identify a user input according to movement of an external object (e.g., the external object 721) in the images. The one or more programs may comprise instructions, when executed by the wearable device, causing the wearable device to display, via the display assembly, a visual object (e.g., the visual object 731) corresponding to the user input.

According to an embodiment, the images may indicate a gaze of one or more eyes a user.

According to an embodiment, the images may indicate a gesture for a portion of a user body.

According to an embodiment, the visual object may include an indicator pointing to a direction of the movement of the external object identified in accordance with the images.

According to an embodiment, the one or more programs may comprise instructions, when executed by the wearable device, causing the wearable device to, based on providing the images in the message from an external data management module (e.g., the external data management module 625) of the wearable device to a service module (e.g., the service module 621) which manages input data of the wearable device, identify the user input.

According to an embodiment, the one or more programs may comprise instructions, when executed by the wearable device, causing the wearable device to display, via the display assembly, the visual object, by providing the user input to a lightweight rendering engine of the wearable device via a virtual space manager of the wearable device.

According to an embodiment, the message may include user input back channel (UIBC) data. A value indicated by a human interface device (HID) type of the UIBC data may indicate the images including the external object.

According to an embodiment, the one or more programs may comprise instructions, when executed by the wearable device, causing the wearable device to, before transmitting the mirroring data to the electronic device, transmit a first message for user input back channel (UIBC) capability negotiation to the electronic device via the communication circuitry. The one or more programs may comprise instructions, when executed by the wearable device, causing the wearable device to, before transmitting the mirroring data to the electronic device, based on receiving a second message indicating a response to the first message from the electronic device via the communication circuitry, establish a connection between the wearable device and the electronic device.

According to an embodiment, the one or more programs may comprise instructions, when executed by the wearable device, causing the wearable device to display the visual object corresponding to the user input via the display assembly. The one or more programs may comprise instructions, when executed by the wearable device, causing the wearable device to, based on receiving another input corresponding to the visual object while displaying the visual object, execute a function corresponding to the movement of the external object in the images.

According to an embodiment, the one or more programs may comprise instructions, when executed by the wearable device, causing the wearable device to display the visual object corresponding to the user input via the display assembly. The one or more programs may comprise instructions, when executed by the wearable device, causing the wearable device to display, via the display assembly, another visual object indicating a guide mode for displaying the visual object based on the images.

As described above, an electronic device (e.g., the electronic device 701) may comprise a display (e.g., the display 703). The electronic device may comprise a camera (e.g., the camera 702). The electronic device may comprise communication circuitry. The electronic device may comprise memory, comprising one or more storage media, storing instructions. The electronic device may comprise at least one processor (e.g., the processor 120) comprising processing circuitry. The instructions, when executed by the at least one processor individually or collectively, may cause the electronic device to receive, from a wearable device (e.g., the wearable device 101), mirroring data (e.g., the mirroring data 710) for a screen (e.g., the screen 730) displayed on the wearable device via the communication circuitry. The instructions, when executed by the at least one processor individually or collectively, may cause the electronic device to display a screen (e.g., the screen 740) according to the received mirroring data via the display. The instructions, when executed by the at least one processor individually or collectively, may cause the electronic device to, while the screen (e.g., the screen 740) for the mirroring data is displayed on the electronic device, obtain images including an external object (e.g., the external object 721) via the camera. The instructions, when executed by the at least one processor individually or collectively, may cause the electronic device to transmit a message (e.g., the message 720, or the message 1110) including the images to the wearable device via the communication circuitry. The images in the message may be used by the wearable device to display a visual object based on the images.

According to an embodiment, the images may indicate a gaze of one or more eyes.

According to an embodiment, the images may indicate a gesture for a portion of a user body.

According to an embodiment, the message may include user input back channel (UIBC) data. A value indicated by a human interface device (HID) type of the UIBC data may indicate the images including the external object.

According to an embodiment, the instructions, when executed by the at least one processor individually or collectively, may cause the electronic device to, before receiving the mirroring data from the wearable device via the communication circuitry, receive a first message for user input back channel (UIBC) capability negotiation from the electronic device via the communication circuitry. The instructions, when executed by the at least one processor individually or collectively, may cause the electronic device to, before receiving the mirroring data from the wearable device via the communication circuitry, based on transmitting a second message indicating a response to the first message to the wearable device via the communication circuitry, establish a connection between the electronic device and the wearable device.

As described above, a method performed in an electronic device (e.g., the electronic device 701) comprising a display (e.g., the display 703), a camera (e.g., the camera 702), and commination circuitry may comprise receiving, from a wearable device, mirroring data (e.g., the mirroring data 710) for a screen (e.g., the screen 730) displayed on the wearable device via the communication circuitry. The method may comprise displaying a screen (e.g., the screen 740) according to the received mirroring data via the display. The method may comprise, while the screen (e.g., the screen 740) for the mirroring data is displayed on the electronic device, obtaining images including an external object (e.g., the external object 721) via the camera. The method may comprise transmitting a message (e.g., the message 720, or the message 1110) including the images to the wearable device via the communication circuitry. The images in the message may be used by the wearable device to display a visual object based on the images.

According to an embodiment, the images may indicate a gaze of one or more eyes.

According to an embodiment, the images may indicate a gesture for a portion of a user body.

According to an embodiment, the message may include user input back channel (UIBC) data. A value indicated by a human interface device (HID) type of the UIBC data may indicate the images including the external object.

According to an embodiment, the method may comprise, before receiving the mirroring data from the wearable device via the communication circuitry, receiving a first message for user input back channel (UIBC) capability negotiation from the electronic device via the communication circuitry. The method may comprise, before receiving the mirroring data from the wearable device via the communication circuitry, based on transmitting a second message indicating a response to the first message from the electronic device via the communication circuitry, establishing a connection between the wearable device and the electronic device.

As described above, a computer-readable storage media in which one or more programs are stored, the one or more programs, may comprise instructions, when executed by an electronic device comprising a display (e.g., the display 703), a camera (e.g., the camera 702), and commination circuitry, causing the electronic device to receive, from a wearable device, mirroring data (e.g., the mirroring data 710) for a screen (e.g., the screen 730) displayed on the wearable device via the communication circuitry. The one or more programs, may comprise instructions, when executed by the electronic device, causing the electronic device to display a screen (e.g., the screen 740) according to the received mirroring data via the display. The one or more programs, may comprise instructions, when executed by the electronic device, causing the electronic device to, while the screen (e.g., the screen 740) for the mirroring data is displayed on the electronic device, obtain images including an external object (e.g., the external object 721) via the camera. The one or more programs, may comprise instructions, when executed by the electronic device, causing the electronic device to transmit a message (e.g., the message 720, or the message 1110) including the images to the wearable device via the communication circuitry. The images in the message may be used by the wearable device to display a visual object based on the images.

According to an embodiment, the images may indicate a gaze of one or more eyes.

According to an embodiment, the images may indicate a gesture for a portion of a user body.

According to an embodiment, the message may include user input back channel (UIBC) data. A value indicated by a human interface device (HID) type of the UIBC data may indicate the images including the external object.

According to an embodiment, the one or more programs may comprise instructions, when executed by the electronic device, causing the electronic device to, before receiving the mirroring data from the wearable device via the communication circuitry, receive a first message for user input back channel (UIBC) capability negotiation from the electronic device via the communication circuitry. The one or more programs may comprise instructions, when executed by the electronic device, causing the electronic device to, before receiving the mirroring data from the wearable device via the communication circuitry, based on transmitting a second message indicating a response to the first message to the wearable device via the communication circuitry, establish a connection between the electronic device and the wearable device.

As described above, the wearable device may comprise a display assembly comprising at least one display. The wearable device may comprise communication circuitry. The wearable device may comprise memory comprising one or more storage media, storing instructions. The wearable device may comprise at least one processor comprising processing circuitry. The instructions, when executed by the at least one processor individually or collectively, may cause the wearable device to transmit mirroring data for a screen representing at least a portion of a three-dimensional space provided via the display assembly to an electronic device via the communication circuitry. The instructions, when executed by the at least one processor individually or collectively, may cause the wearable device to, while providing the mirroring data to the electronic device to display a screen according to the mirroring data on the electronic device, receive, a message including a control command obtained via a camera (e.g., the camera 702) of the electronic device. The instructions, when executed by the at least one processor individually or collectively, may cause the wearable device to execute a function according to the control command in the message. The message may indicate that the control command corresponds to a user input obtained via a camera of the electronic device.

According to an embodiment, the instructions, when executed by the at least one processor individually or collectively, may cause the wearable device to, based on providing the control command in the message from an external data management module of the wearable device to a service module which manages input data of the wearable device, execute the function according to the control command.

According to an embodiment, the message may include user input back channel (UIBC) data. A value indicated by a human interface device (HID) type of the UIBC data may indicate the control command.

According to an embodiment, the instructions, when executed by the wearable device, may cause the wearable device to, before transmitting the mirroring data to the electronic device, transmit a first message for user input back channel (UIBC) capability negotiation to the electronic device via the communication circuitry. The instructions, when executed by the wearable device, may cause the wearable device to, before transmitting the mirroring data from the electronic device, based on receiving a second message indicating a response to the first message from the electronic device via the communication circuitry, establish a connection between the wearable device and the electronic device.

According to an embodiment, the instructions, when executed by the at least one processor individually or collectively, may cause the wearable device to cause the wearable device to execute the function according to the control command in the message. The instructions, when executed by the at least one processor individually or collectively, may cause the wearable device to display, via the display assembly, a visual object indicating a control mode for executing the function according to the control command.

According to an embodiment, a shape of the visual object may change according to movement data included in the message. The movement data may correspond to movement of an external object.

According to an embodiment, when the movement data of the external object indicates that the external object moves in a direction, the control command causes content to move in the direction within the screen.

As described above, a method performed in a wearable device comprising a display assembly comprising at least one display, and communication circuitry may comprise transmitting mirroring data for a screen representing at least a portion of a three-dimensional space provided via the display assembly to an electronic device via the communication circuitry. The method may comprise, while providing the mirroring data to the electronic device to display a screen according to the mirroring data on the electronic device, receiving a message including images obtained via a camera of the electronic device, from the electronic device via the communication circuitry. The method may comprise executing a function according to the control command in the message. The message may indicate that the control command corresponds to a user input obtained via a camera of the electronic device.

According to an embodiment, the method may comprise, based on providing the control command in the message from an external data management module of the wearable device to a service module which manages input data of the wearable device, executing the function according to the control command.

According to an embodiment, the message may include user input back channel (UIBC) data. A value indicated by a human interface device (HID) type of the UIBC data may indicate the control command.

According to an embodiment, the method may comprise, before transmitting the mirroring data to the electronic device, transmitting a first message for user input back channel (UIBC) capability negotiation to the electronic device via the communication circuitry. The method may comprise, before transmitting the mirroring data to the electronic device, based on receiving a second message indicating a response to the first message from the electronic device via the communication circuitry, establishing a connection between the wearable device and the electronic device.

According to an embodiment, the method may comprise executing the function according to the control command in the message. The method may comprise displaying, via the display assembly, a visual object indicating a control mode for executing the function according to the control command.

According to an embodiment, a shape of the visual object may change according to movement data included in the message. The movement data may correspond to movement of an external object.

According to an embodiment, when the movement data of the external object indicates that the external object moves in a direction, the control command causes content to move in the direction within the screen.

As described above, a computer-readable storage media in which one or more programs are stored, the one or more programs may include instructions, when executed by a display assembly comprising at least one display, and communication circuitry, causing the wearable device to transmit mirroring data for a screen representing at least a portion of a three-dimensional space provided via the display assembly to an electronic device via the communication circuitry. The one or more programs may include instructions, when executed by the wearable device, causing the wearable device to, while providing the mirroring data to the electronic device to display a screen according to the mirroring data on the electronic device, receive, a message including a control command, from the electronic device via the communication circuitry. The one or more programs may include instructions, when executed by the wearable device, causing the wearable device to execute the function according to the control command in the message. The message may indicate that the control command corresponds to a user input obtained via a camera of the electronic device.

According to an embodiment, the one or more programs may comprise instructions, when executed by the wearable device, causing the wearable device to, based on providing the control command in the message from an external data management module of the wearable device to a service module which manages input data of the wearable device, execute the function according to the control command.

According to an embodiment, the message may include user input back channel (UIBC) data. A value indicated by a human interface device (HID) type of the UIBC data may indicate the control command.

According to an embodiment, the one or more programs may comprise instructions, when executed by the wearable device, causing the wearable device to, before transmitting the mirroring data to the electronic device, transmit a first message for user input back channel (UIBC) capability negotiation to the electronic device via the communication circuitry. The one or more programs may comprise instructions, when executed by the wearable device, causing the wearable device to, before transmitting the mirroring data to the electronic device, based on receiving a second message indicating a response to the first message from the electronic device via the communication circuitry, establish a connection between the wearable device and the electronic device.

According to an embodiment, the one or more programs may comprise instructions, when executed by the wearable device, causing the wearable device to execute the function according to the control command in the message. The one or more programs may comprise instructions, when executed by the wearable device, causing the wearable device to display, via the display assembly, a visual object indicating a control mode for executing the function according to the control command.

According to an embodiment, a shape of the visual object may change according to movement data included in the message. The movement data may correspond to movement of an external object.

According to an embodiment, when the movement data of the external object indicates that the external object moves in a direction, the control command causes content to move in the direction within the screen.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means”.

What is claimed is:

1. A wearable device comprising:
a display assembly comprising at least one display;
communication circuitry;
memory, comprising one or more storage media, storing instructions; and
at least one processor comprising processing circuitry,
wherein the instructions, when executed by the at least one processor individually or collectively, cause the wearable device to:
transmit, to an electronic device via the communication circuitry, mirroring data for a screen representing at least a portion of a three-dimensional space provided via the display assembly,
while providing the mirroring data to the electronic device to display a screen according to the mirroring data on the electronic device, receive, from the electronic device via the communication circuitry, a message including images obtained via a camera of the electronic device,
based on the images included in the message, identify a user input according to movement of an external object in the images, and
display, via the display assembly, a visual object corresponding to the user input.

2. The wearable device of claim 1, wherein the images indicate a gaze of one or more eyes of a user.

3. The wearable device of claim 1, wherein the images indicate a gesture for a portion of a user body.

4. The wearable device of claim 1, wherein the visual object includes an indicator pointing to a direction of the movement of the external object identified in accordance with the images.

5. The wearable device of claim 1, wherein the instructions, when executed by the at least one processor individually or collectively, cause the wearable device to:
based on providing the images included in the message from an external data management module of the wearable device to a service module which manages input data of the wearable device, identify the user input.

6. The wearable device of claim 1, wherein the instructions, when executed by the at least one processor individually or collectively, cause the wearable device to:
display, via the display assembly, the visual object by providing the user input to a lightweight rendering engine of the wearable device via a virtual space manager of the wearable device.

7. The wearable device of claim 1,
wherein the message includes user input back channel (UIBC) data, and
wherein a value indicated by a human interface device (HID) type of UIBC data indicates the images including the external object.

8. The wearable device of claim 1, wherein the instructions, when executed by the at least one processor individually or collectively, cause the wearable device to:
before transmitting the mirroring data to the electronic device:
transmit, to the electronic device via the communication circuitry, a first message for a user input back channel (UIBC) capability negotiation; and
based on receiving a second message indicating a response to the first message from the electronic device via the communication circuitry, establish a connection between the wearable device and the electronic device.

9. The wearable device of claim 1, wherein the instructions, when executed by the at least one processor individually or collectively, cause the wearable device to:
display, via the display assembly, the visual object corresponding to the user input, and
based on receiving another input corresponding to the visual object while displaying the visual object, execute a function corresponding to the movement of the external object in the images.

10. The wearable device of claim 1, wherein the instructions that, when executed by the at least one processor individually or collectively, cause the wearable device to:
display, via the display assembly, the visual object corresponding to the user input, and
display, via the display assembly, another visual object indicating a guide mode for displaying the visual object based on the images.

11. An electronic device comprising:
a display;
a camera;
communication circuitry;
memory comprising, one or more storage media, storing instructions; and
at least one processor comprising processing circuitry,
wherein the instructions, when executed by the at least one processor individually or collectively, cause the electronic device to:
receive, from a wearable device via the communication circuitry, mirroring data for a screen displayed on the wearable device,
display, via the display, a screen according to the mirroring data received from the wearable device,
while the screen according to the mirroring data is displayed on the display of the electronic device, obtain, via the camera, images including an external object, and
transmit, to the wearable device via the communication circuitry, a message including the images, and
wherein the images included in the message are used by the wearable device to display a visual object based on the images.

12. The electronic device of claim 11, wherein the images indicate a gaze of one or more eyes of a user.

13. The electronic device of claim 11, wherein the images indicate a gesture for a portion of a user body.

14. The electronic device of claim 11,
wherein the message includes user input back channel (UIBC) data, and
wherein a value indicated by a human interface device (HID) type of UIBC data indicates the images including the external object.

15. The electronic device of claim 11, wherein the instructions, when executed by the at least one processor individually or collectively, cause the electronic device to:
before receiving the mirroring data from the wearable device via the communication circuitry:
receive, from the wearable device via the communication circuitry, a first message for a user input back channel (UIBC) capability negotiation; and
based on transmitting to the wearable device via the communication circuitry a second message indicating a response to the first message, establish a connection between the electronic device and the wearable device.

16. A wearable device comprising:
a display assembly comprising at least one display;
communication circuitry;
memory, comprising one or more storage media, storing instructions; and
at least one processor comprising processing circuitry,
wherein the instructions, when executed by the at least one processor individually or collectively, cause the wearable device to:
transmit, to an electronic device via the communication circuitry, mirroring data for a screen representing at least a portion of a three-dimensional space provided via the display assembly,
while providing the mirroring data to the electronic device to display a screen according to the mirroring data on the electronic device, receive, from the electronic device via the communication circuitry, a message including a control command, and
execute a function according to the control command included in the message, and
wherein the message indicates that the control command corresponds to a user input obtained via a camera of the electronic device.

17. The wearable device of claim 16, wherein the instructions, when executed by the at least one processor individually or collectively, cause the wearable device to:
based on providing the control command included in the message from an external data management module of the wearable device to a service module which manages input data of the wearable device, execute the function according to the control command.

18. The wearable device of claim 16,
wherein the message includes user input back channel (UIBC) data, and
wherein a value indicated by a human interface device (HID) type of UIBC data indicates the control command.

19. The wearable device of claim 16, wherein the instructions, when executed by the at least one processor individually or collectively, cause the wearable device to:
before transmitting the mirroring data to the electronic device:
transmit, to the electronic device via the communication circuitry, a first message for a user input back channel (UIBC) capability negotiation; and
based on receiving a second message indicating a response to the first message from the electronic device via the communication circuitry, establish a connection between the wearable device and the electronic device.

20. The wearable device of claim 16, wherein the instructions, when executed by the at least one processor individually or collectively, cause the wearable device to:
execute the function according to the control command included in the message, and
display, via the display assembly, a visual object indicating a control mode for executing the function according to the control command.
